(19) United States
(12) Patent Application Publication
(10) Pub. No.: US 2022/0172308 A1
(43) Pub. Date: Jun. 2, 2022

(54) SYSTEMS, METHODS, AND APPLICATIONS FOR EXCHANGING, TRANSFERRING, OR CONVEYING OBJECTS AND/OR PRODUCTS WITHIN ONE OR MORE COMMUNITIES

(71) Applicant: Lisa Troyano-Ascolese, Hoboken, NJ (US)

(72) Inventor: Lisa Troyano-Ascolese, Hoboken, NJ (US)

(21) Appl. No.: 17/539,665

(22) Filed: Dec. 1, 2021

Related U.S. Application Data
(60) Provisional application No. 63/120,553, filed on Dec. 2, 2020.

(51) Int. Cl. G06Q 50/16; G06F 16/51

(52) U.S. Cl. CPC G06Q 50/16; G06F 16/51

(57) ABSTRACT

Systems, methods, and software applications stage real estate listings and comprise a graphic user interface of a digital device for receiving user input, digital images of staging furniture saved in a database, a digital communication network digitally connecting the digital device and a computer server. Artificial intelligence software selects a digital image of a staging item based on the user input, artificial intelligence hardware executes the artificial intelligence software, and the selected digital image is displayable via one or more digital devices.

### CROSS-REFERENCE TO RELATED APPLICATION

This non-provisional application claims priority to U.S. Provisional Patent Application No. 63/120,553 filed Dec. 2, 2020, which is incorporated herein by reference.

### SUMMARY OF THE DISCLOSURE

The present disclosure is directed to one or more systems, methods, and/or applications that are configured or adapted for swapping, exchanging, leasing, conveying, transferring, sharing, or renting one or more movable objects and/or products within one or more communities. The present systems, methods, and/or applications may facilitate swapping, buying, selling, leasing, conveying, transferring, sharing, renting, and/or exchanging of at least one staging item, object, or article, such as, for example, personal property, furniture, furnishings, decorations, rugs/carpets, marketing/advertising accessories, within at least one local, regional, national, or international real estate community.

Real estate “staging” (hereinafter referred to as “staging”) refers to preparing a real estate property for sale or offer for sale within a real estate marketplace or real estate sales community. One purpose of staging real estate before sale or offer for sale in the marketplace is to improve or increase at least one physical appeal and/or overall appearance of the staged real estate being viewed by potential buyers. As a result of the staging, the real estate property may be sold to a buyer for more money and/or in a faster duration of time when compared to un-staged real estate. There are many known staging techniques which improve or increase the appeal and/or overall appearance of the real estate property such that the potential buyers may experience an increased desire to purchase the real estate property at an increased or higher purchase price or within a shorter or faster duration of time when compared to un-staged real estate.

In embodiments, the real estate property may comprise or may be property consisting of land, at least one land feature, at least one building, or any combination thereof. The real estate may further comprise immovable property, movable property, real property, or any combination thereof. Immovable property may consist of, for example, crops, minerals, forest, water, or any combination thereof, and real property may comprise at least one of one or more buildings, housing/living structures, storage structures, commercial structures, or any combination thereof. In some embodiments, the real estate property may comprise or may be at least one dwelling, such as, for example, at least one multiple-unit dwelling, at least one semi-detached dwelling, at least one detachable dwelling, at least one portable dwelling, at least one commercial building, or any combination thereof. For example, the at least one multiple-unit dwelling may be an apartment or flat, a multi-family house, a terraced house, a townhouse, a condominium, a cooperative dwelling, or any combination thereof. In some embodiments, the at least one semi-detached dwelling may be a duplex, the at least one portable dwelling may be a mobile home, a pre-fabricated home, a houseboat, a structural tent, or any combination thereof, and the at least one commercial building may be a retail shop, a vehicle garage, a warehouse, an office building, a food industry building, a processing or manufacturing building, or any combination thereof. Alternatively, the real estate property may be any physical structure comprising a living space or the like. The present disclosure is not limited to a specific embodiment of the real estate property to be staged via the present systems, methods, and/or applications disclosed herein.

Staging of the real estate for sale on the real estate market often requires at least one financial investment to improve or increase the appeal and/or appearance of the real estate to potential real estate buyers. The real estate staging may require improving the physical appearance or cosmetic appeal of the real estate property and often comprises decorating the real estate to stage or display a more attractive and appealing impression of the real estate property to the potential real estate buyers viewing the staged real estate property. The real estate stage decorating or displaying may include adding one or more stage items, articles, or objects (hereinafter collectively referred to hereinafter as “the at least one stage item”) to the overall appearance of the real estate property. In embodiments, the at least one stage item comprises one or more selected from the group consisting of: at least one art piece; at least one painting; at least one real estate accessory; at least one light or residential lighting element; one or more greenery pieces; one or more carpets or rugs; at least one window treatment element, one or more permanent furniture pieces; one or more structural design elements; one or more “temporarily replace” furniture pieces; at least one landscaping element, or any combination thereof.

In some embodiments, the at least one stage item may be arranged, displayed, or provided within the real estate property to give the potential buyers a more attractive first or subsequent impression of the real estate property. Properly staged real estate may enhance one or more attractive features of the real estate property, while substantially reducing or eliminating one or more flaws, faults, or deficiencies of the real estate property. Different portions, sections, areas, and/or rooms of the real estate property may require differing or varying levels of staging to substantially convincing potential homebuyers to down-play or overlook the flaws, faults, or deficiencies of the real estate property. Therefore, some portions, sections, areas, and/or rooms of the real estate property may be considered more important than others and may require addition of more or less stage items to the staged real estate property.

At least one real estate agent for the seller of the staged real estate property (hereinafter “the seller's agent”) may utilize the systems, methods, and/or applications disclosed herein to determine, identify, and/or select the at least one stage item for arranging within the staged real estate property. The seller's agent may swap, exchange, lease, receive, transfer, share, or rent determined, identified, and/or selected stage item (collectively referred to hereinafter as “the selected stage item”) for displaying at or incorporating into the staged real estate property via the present systems, methods, and/or applications. The present systems, methods, and applications disclosed herein facilitate the preparation and completion of the staged real estate property by the seller's agent and reduce costs and completion times associated with preparing the staged real estate property. At least one real estate agent for a buyer of the staged real estate property (hereinafter “the buyer's agent”) may provide comments, reviews, and/or feed-back to the seller's agent with respect to the staged real estate property via the systems, methods, and/or applications disclosed herein. The staged real estate property may increase its home value by from about 1% to about 10% when directly compared to the un-staged real estate property and may sell from about three to about ten times faster when directly compared to the un-staged real estate property. However, high cost(s) associated with staging the real estate property before sale and paid by the seller and/or the seller's agent may be from about one-hundred dollars to more than about ten-thousand dollars. However, the systems, methods, and applications disclosed herein are usable by the seller and/or the seller's agent to stage the real estate property before sale and/or minimize or reduce the high cost(s) associated with staging the real estate property before sale.

In one or more embodiments, at least one system for staging real estate properties/listings is provided. The system may comprise at least one first digital device having a graphic user interface for receiving user input and/or at least one computer server coupled to at least one database, wherein digital images of staging furniture are saved in the at least one database and accessible via the at least one computer server. Further, the system may comprise a digital communication network connected to the at least one first digital device and the at least one computer server such that the at least one first digital device digitally communicates with the at least one computer server via the digital communication network. Still further, the system may comprise artificial intelligence software configured for selecting at least one digital image of at least one staging item from the digital images of the staging furniture based on the user input received from the at least one first digital device, wherein the at least one staging item comprises staging furniture for staging a room of a real estate listing. Moreover, the system may comprise artificial intelligence hardware for executing the artificial intelligence software and in digital communication with the at least one first digital device and the at least one computer server, wherein the selected at least one digital image of at least one staging item is displayable via the graphic user interface of the at least one first digital device.

In an embodiment, the user input may comprise a geographical location of the real estate listing.

In an embodiment, the user input may further comprise an acceptable geographical radius with respect to the geographical location of the real estate listing.

In an embodiment, the staging furniture may be physically located within the acceptable geographical radius with respect to the geographical location of the real estate listing.

In an embodiment, the user input may be a room type corresponding to the room of the real estate listing and/or dimensions of the room of the real estate listing.

In an embodiment, the system may further comprise at least one computer software application accessible via the at least one first digital device or the at least one computer server and configured to display or render the selected at least one digital image of at least one staging item.

In an embodiment, the artificial intelligence software may comprise one or more data analysis algorithms and/or the artificial intelligence hardware may comprise one or more computer-generated sensory inputs.

In an embodiment, the artificial intelligence hardware may comprise at least one artificial intelligence accelerator selected from the group consisting of at least one graphics processing unit, at least one integrated graphics processor, at least one field programmable gate array, at least one application specific integrated circuit, or a combination thereof.

In an embodiment, the system may further comprise a virtual reality or augmented reality staged real estate listing accessible via the at least one first digital device or the at least one computer server and comprising the room of the real estate listing staged with the selected at least one digital image of at least one staging item.

In one or more embodiments, at least one method for stagging rooms of real estate properties/listings is provided and may comprise analyzing information associated with a plurality of staging furniture based on user input received from a first digital device, wherein information of the plurality of staging furniture is accessible from a database in digitally communication with the first digital device and comprises a geographical location of each furniture item of the plurality of staging furniture, the user input comprises a geographical location of a real estate listing to be staged and an acceptable geographical radius around the geographical location of the real estate listing. Further, the method may comprise selecting at least one furniture item from the plurality of staging furniture based on the analyzed information when the geographical location of the at least one furniture item is located within the acceptable geographical radius around the geographical location of the real estate listing. Moreover, the method may comprise displaying the selected at least one furniture item via a computer software application that is accessible and displayable via the first digital device or at least one second digital device.

In an embodiment, the method may further comprise obtaining the selected at least one furniture item for staging at least one room of the real estate listing.

In an embodiment, the method may further comprise staging at least one room of the real estate listing with the selected at least one furniture item.

In an embodiment, the method may further comprise creating a staged room of the real estate listing by incorporating the selected at least one furniture item into the staged room of the real estate listing.

In an embodiment, the method may further comprise executing or performing one or more data analysis algorithms associated with artificial intelligence software when analyzing the information associated with the plurality of staging furniture based on the user input received from the first digital device.

In an embodiment, the one or more data analysis algorithms may be executed or performed by artificial intelligence hardware.

In an embodiment, the artificial intelligence hardware may comprise at least one artificial intelligence accelerator selected from the group consisting of at least one graphics processing unit, at least one integrated graphics processor, at least one field programmable gate array, at least one application specific integrated circuit, or a combination thereof.

In one or more embodiments, at least one method for stagging rooms of real estate properties/listings is provide and may comprise digitally communicating user input from a first digital device to a computer server via a first digital communication network, wherein the computer server is coupled to a database comprising digital images indicative of staging furniture and executing artificial intelligence software to analyze information associated with the staging furniture based on the user input. Further, the method may comprise determining at least one furniture item from the staging furniture for virtually staging a room of a virtual real estate listing based on the analyzed information and the user input, wherein the user input comprises a room type indicative of the room of the virtual real estate listing. Still further, the method may comprise incorporating, via the artificial intelligence software, at least one digital image of the determined at least one furniture item into the virtually staged room of the virtual real estate listing. Moreover, the method may comprise rendering at least one digital image of the virtually staged room.

In an embodiment, artificial intelligence hardware may execute the artificial intelligence software and/or may comprise at least one artificial intelligence accelerator selected from the group consisting of at least one graphics processing unit, at least one integrated graphics processor, at least one field programmable gate array, at least one application specific integrated circuit, or a combination thereof.

In an embodiment, the method may further comprise generating a virtual tour of the virtual real estate listing comprising the at least one digital image of the virtually staged room.

In an embodiment, the at least one digital image of the virtually staged room is a virtual or augmented reality of the virtual real estate listing and comprises the at least one digital image of the determined at least one furniture item.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a box diagram of a system and components of the system for implementing the methods disclosed herein, according to one or more examples of the present disclosure.

FIG. 2 illustrates a flowchart of a method to be implemented via the system shown in FIG. 1, according to one or more examples of the present disclosure.

### DETAILED DESCRIPTION

As a preliminary matter, it will readily be understood by one having ordinary skill in the relevant art that the present disclosure has broad utility and application. As should be understood, any embodiment may incorporate only one or a plurality of the disclosed aspects herein of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

The systems, methods, and/or applications disclosed herein may facilitate swapping, buying, selling, leasing, conveying, transferring, sharing, renting, and/or exchanging of the at least one staging item within at least one local, regional, national, or international real estate community. The present systems, methods, and mobile applications aid, support, help the seller's agent to better afford and logistically provide the at least one staging item for one or more staged real estate property to be list for sale and/or sold by the seller's agent. In some embodiments, staging of the real estate property may be necessary to finalize sale of the real estate property to a potential buyer, and costs associated with the staging may have a substantial effect on the final sale price of staged real estate property.

The present systems, methods, and applications disclosed herein may help or aid faster sale of staged real estate properties for higher prices than non-staged properties and/or help or aid seller agents to retain one or more clients by allowing the seller agents to provide the stage items and services at no or lower costs to the real estate property sellers. The present systems, methods, and applications disclosed herein may facilitate a level playing field to real estate market participates by ensuring agent selections are based on experience, enthusiasm and talent and not by financial burden the agents are offering to take on that the agents' competition will accept. In short, the present systems, methods, and applications disclosed herein facilitate the swapping, buying, selling, leasing, transferring, renting and/or exchanging the at least one staging item for staging real estate property or real estate sales/rentals. The present systems, methods, and applications disclosed herein provide the at least one staging item (i.e., staging furniture or the like) which may result in no inventory being owned and stored by real estate agents and may save thousands of dollars of traditional overhead by the real estate agents. Staging item sharing systems, methods, and applications are disclosed herein that may provide proper logistics and access and fix a problem that realtors have faced for several years and would otherwise make the realtors lose more than one listing opportunities. Profession real estate stagers may also utilize the present systems, methods, and applications disclosed herein to reduce or avoid any high carrying costs associated with staging furniture. As a result, the professional stages may still be hired by real estate agents for more reasonable amounts but without the costly overhead amounts associated currently with maintaining staging furniture inventories.

The present disclosure is directed to stage item sharing systems and methods (i.e., the present systems/methods) to facilitate swapping, buying, selling, leasing, conveying, transferring, sharing, renting, and/or exchanging at least one staging item or furniture within at least one real estate market or community.

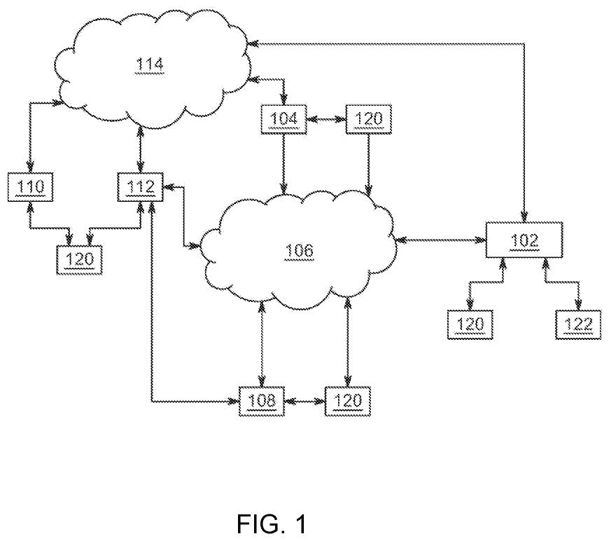

In some embodiments, FIG. 1 illustrates a system 100 of the present disclosure configure to share the at least one staging item with at least one realtor for staging real estate property for sale in a real estate market or community. In an embodiment, the at least one staging item may be staging furniture and the at least one realtor may be the seller's agent offering the stage real estate property for sale in the real estate market or community. Components of the system 100 may be utilized, accessed, and/or activated by one or more users (not shown in the drawings) of the system 100. In embodiments, the one or more users may comprise one or more realtors, one or more real estate seller agents, one or more real estate buyer agents, one or more professional real estate stagers, or any combination thereof. The system 100 provides, enables, and/or facilitates sharing of the at least one staging item between the users of the system 100.

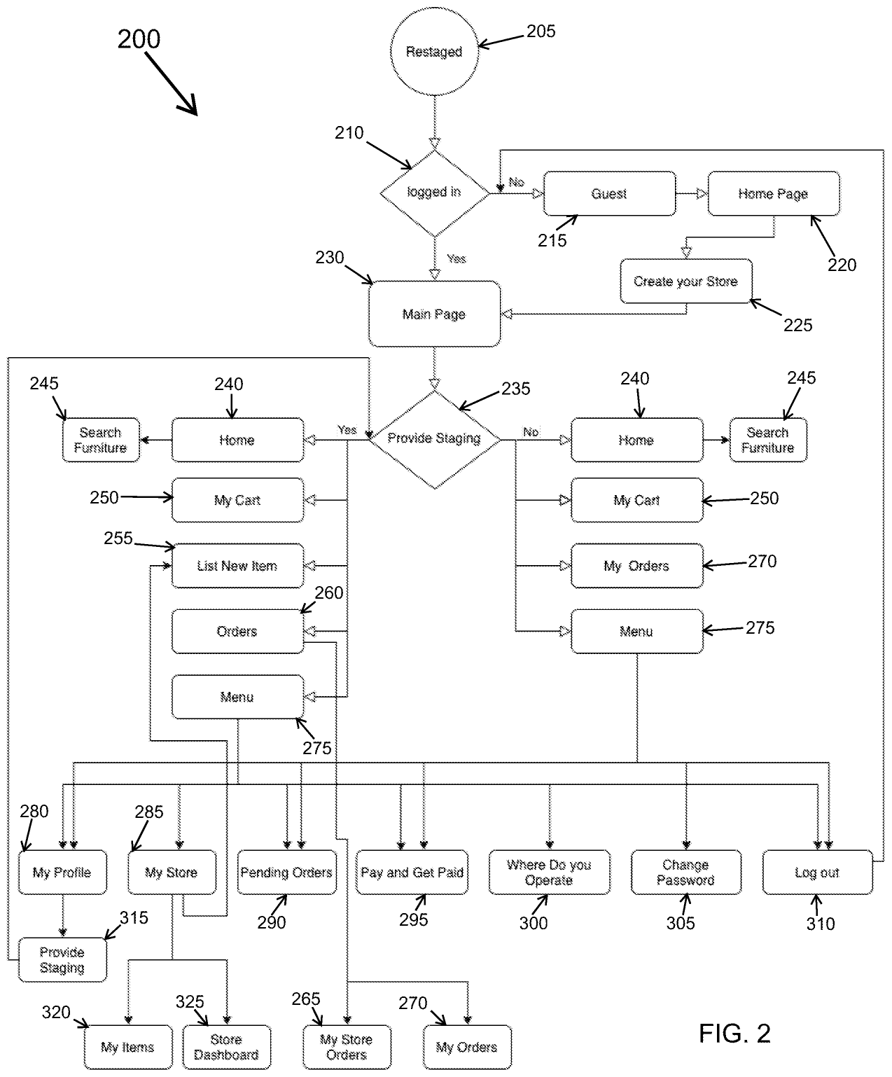

In some embodiments, at least one first user of the system 100 may offer to buy, sell, lease, exchange, or rent the at least one staging item to or from at least one second user of the system 100. The first user of the system 100 may have or own or be willing to rent or sell the at least one staging item and the second user of the system may desire or be looking to rent, buy, lease, or purchase the at least one staging item. The system 100 and/or method 200 (see FIG. 2) disclosed herein may comprise at least one first digital device 102 accessible and/or usable by the first user (hereinafter “the first device 102”) and at least one second digital device 104 accessible and/or usable by the second user (hereinafter “the second device 104”). The system 100 is configured and/or adapted to facilitate, provide, transmit, and/or receive electronic and/or digital communications between the first device 102 and the second device 104 with respect to the buying, selling, purchasing, leasing, renting, exchanging, and/or transferring the at least one staging item. Moreover, multimedia data (i.e., at least one digital image and/or photograph) of the at least one staging item along with digital information associated with and/or describing the at least one staging item may be rendered, displayed, implemented and/or accessible by the first user via the first device 102 and/or by the second user via the second device 104 (collectively referred to hereinafter as “the devices 102, 104”).

The at least one staging item may be bought, purchased, rented, leased, obtained by the second user from the first user via the system 100 and the devices 102, 104 of the system 100. After being bought, purchased, rented, leased, or obtained by the second user via the system 100, the at least one staging item may be delivered to the second user, a real estate property to be staged by the second user, at least one delivery, moving, shipping, and/or transportation services, or any combination thereof. The at least one staging item may be added to, incorporated into, or displayed at the real estate property to be staged by the second user. As a result, the staged real estate property offered for sale by the second user may comprise or include the at least one staging item and the at least one staging item may improve the appeal and/or appearance of the stage real estate property to one or more potential buyers of the staged real estate property. After the staged real estate property has been purchased by or sold to a real estate buyer or the buyer's agent, the at least one staging item may be returned to the first user of the system 100, to a third-party vendor or storage provider, subsequently sold, lease, rented or purchased by a third-party purchaser, or any combination thereof.

In embodiments, the devices 102, 104 may be one or more portable digital devices, one or more handheld digital devices, one or more computer terminals, or any combination thereof. In embodiments, the devices 102, 104 may be a wired terminal, a wireless terminal, or any combination thereof. For example, the devices 102, 104 may be wireless electronic media device, such as, for example, a tablet personal computer (hereinafter “PC”), an ultra-mobile PC, a mobile-based pocket PC, an electronic book computer, a laptop computer, a video game console, a digital projector, a digital television, a digital radio, a media player, a portable media device, a personal digital assistant, an enterprise digital assistant, and/or any combination thereof. In other embodiments, the devices 102, 104 may be, for example, a hyper local digital device, a location-based digital device, a GPS-based digital device, a mobile device (i.e., a 5G+ mobile device, a 5G mobile device, a 4G mobile device, a 3G mobile device), an ALL-IP electronic device, an information appliance, a personal communicator or any combination thereof. The present disclosure should not be deemed as limited to specific embodiments of the devices 102, 104.

The devices 102, 104 may each have at least one display for displaying or rendering the digital information and/or the multimedia data at least temporarily stored in a memory or in at least one digital storage device accessible by microprocessors (not shown in the drawings) of the devices 102, 104. The digital communications, the multimedia data, and/or digital information associated with the at least one staging item may be streamed to the devices 102, 104 via a first digital communication network 106 (hereinafter “the first network 106”), and/or the devices 102, 104 may be in digital communication with each other via or over the first network 106. In an embodiment, one or more digital displays of each of the devices 102, 104 may be or comprise at least one digitized touch-screen and at least one touch-screen graphic user interface (collectively referred to hereinafter as “the GUI”) connected to the microprocessors of the devices 102, 104. In embodiments, the GUI of the first device 102 may facilitate, permit, and/or allow user interaction and/or communication by the first user with the first device 102, and the GUI of the second device 104 may facilitate, permit, and/or allow provider interaction and/or communication by the second user with the second device 104.

The GUIs of the devices 102, 104 may facilitate, permit, and/or allow interactions and/or communications with devices 102, 104 by way of or via one or more graphical elements, one or more audio elements, and/or text-based elements. In some embodiments, one or more display links of the one or more audio elements may facilitate, permit, and/or allow interactions and/or communication with the devices 102, 104 via the GUIs of the devices 102, 104. In other embodiments, the GUIs of the devices 102, 104 may facilitate, permit, and/or allow interactions and/or communications with devices 102, 104 by way of or via one or more graphical elements and/or one or more display links, instead of through use of a pure text-based elements or interface. The one or more graphical elements, the one or more text-based elements, and/or the one or more display links may be, may comprise, and/or may include one or more windows, one or more icons, one or more widgets, one or more sliders, one or more text boxes, one or more buttons, one or more menus, one or more screens one, or more digital avatars, or any combination thereof. The one or more graphical elements, the one or more text-based elements, and/or the one or more display links may be selected, highlighted, moved, activated, and/executed through use of the GUIs of the devices 102, 104 and/or via at least one pointing device (i.e., a mouse, a stylus, a digital writing device, a human finger or thumb, or a combination thereof) associated with and/or in digital communication with the devices 102, 104. The displays, the GUIs, and/or the pointing devices of the devises 102, 104 may be configured and adapted to support touch and multi-touch manipulation by the first user and/or the second user (collectively referred to hereinafter as “the first and second users”). In some embodiments, two or more screens of the GUIs of the devices 102, 104 may be linked together into a workflow of the system 100 and/or the method 200. The workflow and/or navigation between two or more screens of the GUIs of the devices 102, 104 may be facilitated, executed, and/or performed in one or more method steps indicative of the method 200.

The one or more digital displays and/or the GUIs of at least one of the devices 102, 104 may display, render, provide, and/or facilitate the digital communications, the multimedia data, and the digital information associated with or indicative of the at least one staging item. The devices 102, 104 may display, render, provide, and/or facilitate real-time audio and/or visual teleconferencing between the first and second users. Moreover, selectable and/or streamable digital information, digital data and/or multimedia data of the at least one staging item may be rendered, accessed, and/or activated by the devices 102, 104 which may include one or more web sites, one or more web applications, one or more web pages, digital media, one or more IP addresses, audio files or signals, video files or signals, image files or signals, one or more e-mail servers and/or the like.

In embodiments, the devices 102, 104 may have one or more communication components for connecting to and/or communicating with the first network 106. In an embodiment, the one or more communication components of the devices 102, 104 may be a wireless transducer (not shown in the drawings), such as, for example, a wireless sensor network device, such as, for example, a Wi-Fi network device, a wireless ZigBee device, an EnOcean device, an ultra-wideband device, a wireless Bluetooth device, a wireless Local Area Network (hereinafter LAN) accessing device, a wireless IrDA device, or any combination thereof. The present disclosure should not be deemed as limited to specific embodiments of the wireless transducer.

The devices 102, 104 may connect to and/or may access the first network 106 via the one or more communication components of the devices 102, 104. In an embodiment, the devices 102, 104 may be connected to and/or in digital communication with each other via or over the first network 106. In another embodiment, the device 102, 104 may be directly connected to and/or in direct digital communication with each other. In yet another embodiment, a resolver (not shown in the drawings) may be integrated into, or part of, the devices 102, 104. In embodiments, the resolver may be an internet and/or intermediary resolver specifically assigned to the devices 102, 104 and/or provided by an internet service provider of, or associated with, the devices 102, 104.

The devices 102, 104, the resolver, and/or at least one computer server 108 (hereinafter “the server 108”) may be connected to, in digital communication, and/or accessible via the first network 106 of the system 100. As a result, the devices 102, 104 and/or the resolver may be in digital communication with the server 108 and may access at least one internet-accessible resource (hereinafter “internet-accessible resource”) via the first network 106. The internet-accessible resource is associated with or indicative of the at least one staging item and may comprises at least one of the multimedia data, the digital communications and/or information, at least one web site, at least one web page, at least one web application, at least one mobile application, at least one e-mail server, digital information, digital data, digital media content, or any combination thereof. In embodiments, at least one artificial intelligence (hereinafter AI“)” resource/component and/or at least one machine learning software (hereinafter “MLS”) resource/component may be accessible and/or activatable by the devices 102, 104 and/or the server 108 via the first network 106. In some embodiments, the devices 102, 104 and/or the server 108 may utilize, execute, and/or access the at least one AI-based resource/component and/or ML-based resource/component locally or remotely over a cloud server or other digital communication network. In at least one embodiment, the server 108 may be a cloud-based server that is in digital communication with and accessible by the devices 102, 104 over the first network 106.

In embodiments, the devices 102, 104, and/or the server 108 may be directly connected and/or in direct digital communication with a database 110 and/or an interface 112. In other embodiments, the devices 102, 104 and/or the server 108 may be connected to the database 110 and/or the interface 112 via a second digital communication network 114 (hereinafter “the second network 114”). In at least one embodiment, server 108 may be a cloud-based server that is in digital communication with and accessible by the devices 102, 104 over the second network 114. As a result, the database 110 may be a cloud-accessible database that is in digital communication with and accessible by the devices 102, 104, the server 108, the interface 112, or any combination thereof over the first network 106, the second network 114, or a combination thereof.

In some embodiments, the system 100 comprises at least one AI-enabled software 120 (hereinafter “the AI software 120”) comprising at least one of the AI-based resource/component, the ML-based resource/component, or a combination thereof. The AI software 120 may in digital communication with and/or accessible by the devices 102, 104, the server 108, the interface 112, or any combination thereof over the first network 106, the second network 114, or a combination thereof. In an embodiment, at least one of the AI software 120, the resources/components therein, or a combination thereof is cloud-based AI software that is in digital communication with and/or accessible by the devices 102, 104, the server 108, the interface 112, or any combination thereof over the first network 106, the second network 114, or a combination thereof. As a result, cloud-based AI software may be implemented and/or executable by at least one of the devices 102, 104, the server 108, the interface 112, or any combination thereof over the first network 106, the second network 114, or a combination thereof.

In at least one embodiment, the system 100 is a cloud-based system and one or more of the components of the system 100 (i.e., the server 108, the database 110, the interface 112, or any combination thereof) are cloud-based system components. In other embodiments, the interface 112 is a cloud-bases server such that the devices 102, 104 and/or the server 108 may be in digital communication with and/or may access the database 110 and/or the AI software 120 via the cloud-base server (i.e., interface 112) over the first network 106, the second network 114, or a combination thereof.

The database 110 may be a memory or storage medium that is local with respect to the devices 102, 104, and/or the server 108 or may be located remotely with respect to the devices 102, 104 and/or the server 108 whereby “remotely” means positioned at a different physical location than the physical location of the devices 102, 104 and/or the server 108. Similar to the database 110, the interface 112 may be located locally or remotely with respect to the devices 102, 104 and/or the server 108. In an embodiment, the system 100 and/or the database 110 may comprise one or more additional systems and/or may be distributed across multiple servers, multiple cloud-bases servers, datacenters, or any combination thereof (not shown in the drawings). The at least one AI-based resource and/or MLS-based resource may be accessible and/or activatable by the devices 102, 104 and/or the server 108 via the database 110 and/or the interface 112 over the first network 106, the second network 114, or a combination thereof. The devices 102, 104, the server 108, the database 110, and/or the interface 112 may be digitally connected and/or in digital communication with each other via the first network 106 and/or the second network 114.

A memory, digital storage device and/or non-transitory computer-readable medium, which may be accessed and/or executed by a microprocessor incorporated into or included within the system 100, the devices 102, 104, the server 108 and/or the interface 112, may have stored thereon executable computer-implemented instructions, computer programs, one or more algorithms and/or software that, when executed by the microprocessor, perform one or more computer-implemented steps and/or sub-steps of the present methods and applications disclosed herein. In embodiments, the executable instructions, computer programs, algorithms, and/or software may be AI-based and/or MLS-based or -optimized executable instructions, computer programs, algorithms, and/or software. The present AI-based and/or MLS-based applications, software, and/or tools may be executed by the devices 102, 104, the server 108 and/or the interface 112 via the AI-based and/or MLS-based or -optimized executable instructions, computer programs, algorithms, and/or software. In some embodiments, the AI-based and/or MLS-based or -optimized executable instructions, computer programs, algorithms, and/or software may be accessible and/or executable locally with respect to the devices 102, 104, the server 108, and/or the interface 112. In at least one embodiment, the AI-based and/or MLS-based or -optimized executable instructions, computer programs, algorithms, and/or software may be accessible and/or executable via a cloud-based server (i.e., the server 108) over the first network 106, the second network 114, or a combination thereof. In some embodiments, the GUIs of the devices 102, 104 may be web-based, for example, with one or more parts of one or more pages being loaded from the server 108, the database 110, and/or the interface 112, or may natively-compiled to execute on at least one of the devices 102, 104, even when the first network 106 and/or the second network 114 (collectively referred to hereinafter as “the networks 106, 114”) may not be or are not available to the devices 102, 104.

In embodiments, the networks 106, 114 may be, for example, a personal area network (PAN), a local area network (LAN), a campus area network (CAN), a Metropolitan area network (MAN), a wide area network (WAN) and/or the like. In an embodiment, the networks 106, 114 may be a wireless network, such as, for example, a 5G+ network, a 5G network, a 4G network, a 3G network, a wireless MAN, a wireless LAN, a wireless PAN, a Wi-Fi network, a WiMAX network, a global standard network, a personal communication system network, a pager-based service network, a general packet radio service, a universal mobile telephone service network, a radio access network and/or the like. In an embodiment, the networks 106, 114 may be a fixed network, such as, for example, an optical fiber network, an Ethernet, a cabled network, a permanent network, a power line communication network and/or the like. In another embodiment, the networks 106, 114 may be a temporary network, such as, for example, a modem network, a null modem network and/or the like. In yet another embodiment, the networks 106, 114 may be an intranet, extranet or the Internet which may also include the world wide web. The present disclosure should not be limited to a specific embodiment of the networks 106, 114.

The present disclosure should not be deemed as limited to a specific number of digital devices, computer servers, cloud-based servers, databases, digital communication networks, resolvers, user interfaces, AI-based resources/components, and/or MLS-based resources/components which may access and/or may utilize the present systems and/or methods disclosed herein. The present systems and/or methods disclosed herein may include and/or incorporate any number of digital devices, computer servers, databases, digital communication networks, resolvers, user interfaces, AI-based resources/components, and/or MLS-based resources/components as known to one of ordinary skill in the art. In some embodiments, the system 100 shown in FIG. 1 and the method 200 shown in FIG. 2 may include and/or incorporate any number of digital devices, computer servers, databases, digital communication networks, resolvers, user interfaces, AI-based resources/components, and/or MLS-based resources/components as known to one of ordinary skill in the art.

The at least one of the AI-based resource/component, MLS-based resource/component, the AI software 120, or any combination thereof usable or utilized by the system 100 and the method 200 may include or comprise one or more techniques that enable one or more machines or computers of the system 100 (i.e., the devices 102, 104, the server 108, the database 110, and/or the interface 112) to mimic at least one human behavior. In embodiments, the one more techniques may comprise machine MLS-based techniques which are a subset of AI comprising one or more statistical methods to enable the one or more machines or computers of the system 100 to improve with experience over time. The one or more statistical methods of the present systems, methods, and applications disclosed herein are at least one method selected from supervised learning, unsupervised learning, semi-supervised learning, reinforcement learning, deep learning, and at least one combination thereof. Supervised learning may comprise at least one selected from regression, classification, and at least one combination thereof. Unsupervised learning may comprise at least one selected from clustering, dimensionality reduction, and at least one combination thereof. Semi-supervised learning may comprise at least one selected from self-training, one or more low density separation models, one or more graph-based algorithms, and at least one combination thereof. Reinforcement learning may comprise at least one selected from dynamic programming, one or more Monte Carlo methods, one or more Heuristic methods, and at least one combination thereof. Deep learning is a subset of the machine learning (hereinafter “ML”) that is configured, adapted, or programmed to make computations of one or more multi-layer neural networks feasible. Deep learning may comprise at least one artificial neural network selected from at least one recurrent neural network (hereinafter “the RNN”), at least one convolutional neural network, and at least one combination thereof.

Architectures of the at least one AI-based and/or MLS-based resource/component disclosed herein comprises at least one of the RNN and AI software 120 (hereinafter “the AI software 120”) as shown in FIG. 1. In some embodiments, the at least one AI-based and/or MLS-based resource/component and/or the AI software 120 may be, at least partially or entirely, web-based and/or cloud-based, for example, with one or more parts of AI software 120 being loaded from and/or executable via the server 108, the database 110, the interface 112, and/or a cloud-based server (i.e., the server 108). Further, the at least one AI-based and/or MLS-based resource/component and/or the AI software 120 may be locally- or natively-compiled to execute on at least one of the devices 102, 104, even when the networks 106, 114 may not be or are not available to the devices 102, 104. Alternatively, the at least one AI-based and/or MLS-based resource/component and/or the AI software 120 may be a combination of web-based and locally- or natively-compiled such that the devices 102, 104 and the AI software 120 require fewer computing assets or resources and/or improve AI processing speeds achievable by the systems, methods and/or applications disclosed herein.

The AI software 120 of the present systems, methods, and applications disclosed herein may comprise and/or include at least one classifier, model, or network selected from a fully recurrent network, at least one Elman network, at least one Jordan network, a Bayesian network, a Hopfield network, an Echo state network, an independently RNN, a recursive network, a neural history compressor network, a second order RNN, a long short-term memory (hereinafter “LSTM”) network, a gated recurrent unit network, a bi-directional LSTM network, a continuous-time network, a hierarchical network, a recurrent multilayer perceptron network, a multiple timescales model network, at least one neural Turing machine, a differentiable neural computer network, a neural network pushdown automata, at least one memristive network, and at least one combination thereof. In embodiments, the at least one classifier, model, or network may be at least one neural network with a non-conventional number of nodes at one or more layers and/or may comprise one or more hidden layers.

The AI software 120 of the present systems, methods, and applications disclosed herein may be accessed, utilized, activated, and/or implemented by at least one of the devices 102, 104, the server 108, the database 110, the interface 112, or any combinations thereof. As a result, the AI software 120 of the present systems, methods, and applications may solve one or more problems associated with the at least one staging item and/or the first and second users via GUIs of the devices 102,104 over the networks 106, 114. Further, the AI software 120 may power and/or facilitate at least one digitally-rendered avatar on the GUIs such that the avatar may solve the one or more problems associated with the at least one staging item and/or the first and second users via the GUIs of the devices 102, 104.

In embodiments, the present AI-based or MLS-based resource/component and/or the AI software 120 may be performed, executed, and/or implemented either locally or remotely with respect to at least one of the devices 102, 104, the server 108, the database 110, the interface 112, or any combination thereof. For example, the present AI applications or tools and/or the AI software 120 may be performed, executed, and/or implemented locally or what is known as IA-on-the-edge. Alternatively, the present AI applications, software, and/or tools may be performed, executed, and/or implemented in a cloud server system or at another remote location.

In embodiments, the present AI applications or tools and/or the AI software 120 may be performed, executed, and/or implemented on at least one AI-based and/or MLS-based hardware 122 (collectively referred to hereinafter as “the AI-based hardware 122”) as shown in FIG. 1. At least one of the devices 102, 104, the server 108, the database 110, the interface 112, or any combination thereof may comprise, implement, and/or include or be enabled by the AI-based hardware 122. Further, the devices 102, 104, the server 108, the database 110, the interface 112, or any combination thereof may be in digital communication with and/or enabled by the AI-based hardware 122. In some embodiments, the AI-based hardware 122 may be accessed, enabled, and/or activated by the devices 102, 104, the server 108, the database 110, the interface 112, or any combination thereof to implement, execute and/or utilize the AI software 120 of the present systems, methods, and applications disclosed herein.

The AI-based hardware 122 of the present systems, methods, and applications disclosed herein may comprise or consist of at least one AI-based or MLS-based central processing unit (hereinafter “CPU”), at least one AI-based or MLS-based graphics processing unit (hereinafter “GPU”), at least one AI-based or MLS-based integrated graphics processor (hereinafter “IGP”), at least one AI-based or MLS-based field programmable gate array (hereinafter “FPGA”), at least one AI-based or MLS-based application specific integrated circuit (hereinafter “ASIC”), or any combination thereof. In embodiments, the AI-based hardware 122 may comprise at least one AI-specific and/or AI-optimized CPU, GPU, IGP, FPGA, ASIC, or any combination thereof. In at least one embodiment, the AI-based hardware 122 may comprise at least one CPU and at least one AI accelerator selected from the group consisting of at least one GPU, at least one FPGA, at least one ASIC, or any combination thereof. For example, the AI-based hardware 122 may be AI-specific integrated circuits and/or AI-optimized GPUs. Further, the AI-based hardware 122 may comprise one or more analog AI cores, one or more AI-optimized systems, one or more AI-optimized computer chips, one or more AI application-specific computer chips, one or more digital AI cores, heterogeneous integration, machine intelligence, ML quantum computing, or at least one combination thereof. Moreover, the AI-based hardware 122 may comprise one or more AI accelerators and/or may be configured and/or adapted such that performance, execution, and/or implementation of the present AI applications tools and/or the AI software 120 may be improved, accelerated and/or increased by the AI-based hardware 122 of the present systems, methods, and applications disclosed herein.

In some embodiments, the present systems, methods, and applications disclosed herein may utilize, implement, and/or execute one or more of the following computing-based technologies; one or more application programming interfaces (hereinafter “APIs”) providing connections between the devices 102, 104, the server 108, the interface 112, the database 110, the AI software 120, the AI-based hardware 122, or any combination thereof; one or more runtime environments running on an engine and executing code outside application software for accessing the World Wide Web; one or more database management system for maintaining the database 110 and/or additional databases of the system 100 (not shown in the drawings); one or more computing and development tools or platforms for creating mobile applications and/or web applications; one or more computing web services, one or more on-demand cloud computing platforms and/or APIs, one or more payment processing software and APIs for e-commerce websites and mobile application, or any combination thereof. One or more components of the system 100 and/or one or more steps or sub-steps of the method 200 may include, incorporate, execute, and/or utilize the above-mentioned one or more computing-based technologies to achieve the novel and inventive systems, methods, and applications disclosed herein.

In embodiment, the one or more computing-based technologies may comprise at least the following computer-based technologies: at least one open-source, cross-platform, back-end JavaScript runtime environment; at least one open-source relational database management system; at least one platform for creating mobile and web applications; at least one storage infrastructure providing object storage through a web service interface; at least one software as a service provider; at least one financial service provider; at least one payment processor; or any combination thereof. For example, the computer-based technologies of the present systems, methods, and applications disclosed herein may comprise at least one selected from: Node.js. Prostgres or PostgreSQL; Firebase for generating, transmitting, utilizing one or more notifications; Amazon Web Services Simple Storage Service (hereinafter “AWS S3”) bucket for saving, storing, retrieving, and/or transmitting images of the present systems, methods, and applications disclosed herein; at least one financial services provider, such as, for example, Stripe, Inc.; or any combination thereof. In at least one embodiment, the object storage through the web service interface may store, save, retrieve, and/or transfer digital images of, associated with, and/or indicative of at least one of the at least one staging item, the real estate property to be staged by the seller's agent, the resulting staged real estate property, the seller's agent, the buyer's agent, available staging furniture, unavailable staging furniture, other imagery relevant to or associated with the systems, methods, and applications disclosed herein, or any combination thereof.

The systems, methods and applications disclosed herein may provide the one or more web-based, cloud-based, and/or AI-enabled platforms and interfaces that allow for the seller's agent to obtain the at least one staging items for staging real estate property prior to offering the real estate property for sale to one or more potential buyers. The seller's agent may buy, purchase, rent, lease, borrow the at least one staging item from a second user of the system 100. As a result, the system 100 and/or method 200 of the present disclosure may facilitate the staging of the real estate property by the seller's agent in addition to the conveyance or transfer of the at least one staging item from the second user to the seller's agent. Additionally, the system 100 and/or the method 200 may also facilitate a commercial/financial transaction and/or monetary exchange between the seller's agent and the second user for the conveyance or transfer of the at least one staging items to the seller's buyer.

In embodiments, FIG. 2 illustrates a “restaged” application and/or method 200 (collectively referred to hereinafter as “the method 200”) that may be powered by or implemented via the AI-based or MLS-based resource/component, the AI software 120, the AI-based hardware 122, or any combination thereof of the system 100. The method 200 may facilitate trading, exchanging, transferring or conveying staging objects, items, and/or furniture within one or more real estate sales or marketing communities. In some embodiments, the method 200 utilizes the components of the system 100 shown in FIG. 1 such that a first user or seller's agent may add the staging objects, items, and/or furniture to real estate property prior to offering the real estate property for sale to one or more potential buyers or buyer's agents. As a result, the first user or seller's agent may showcase the staged real estate property to the potential buyers or buyer's agent which may downplay, reduce or limit one or more deficiencies of the real estate property. Further, the potential buyer or buyer's agent may buy or offer to buy the staged real estate property from the seller's agent.

In some embodiments, the one or more components of the system 100 and/or one or more steps/sub-steps of the method 200 may utilize one or more signable web tokens for creating data within the system 100 and/or method 200. Further, the one or more signable web tokens may be signed using a private secret, a public/private key, or a combination thereof. In an embodiment, the one or more signable web tokens may be or comprise at least JavaScript Object Notation (hereinafter “JSON”) Web Token (hereinafter “the at least one JWT token”) that creates data with optional signature and/or optional encryption having a payload that holds or maintains the JSON. Still further, one or more steps/sub-steps of the method 200 utilize one or more APIs to collect and/or retain entered data or information and store and/or maintain the entered data or information within the database 110 and/or other databases associated with the system 100 and/or method 200.

In some embodiments, the first user or seller's agent (hereinafter “the seller's agent”) may open the “restaged” application by selecting an icon indicative of the “restaged” application displayed on the first device 102 as shown at step 205 of the method 200. The “restaged” application may be accessible by the first 102 with or without data communications over the first and second networks 106, 114. The seller's agent may then be prompted to either log-in to an account created withing the “restaged” application or to continue thereafter as a “guest” as shown in step 210. If the seller's agent selects “no” to being logged in, then the seller's agent may continue as a “guest” as shown at step 215 and the “home page” of the “restaged” application is displayed to the seller's agent via the first device 102 as shown at step 220. Subsequent to displaying the “home page”, the seller's agent creates a “guest store” via the first device 102 as shown at step 225 and the first device 102 continues to and/or displays a “main page” of the “restaged” application to the seller's agent as shown at step 230.

Alternatively, the seller's agent may have already created and/or registered a user account, profile, and/or store within the “restaged” application and may log into said user account, profile, and/or store at step 210. As a result of “logging in”, the first device 102 may display the “main page” to the seller's agent as set forth at step 230. Prior to logging into said account, profile, and/or store at step 210, the seller's agent may have created and/or registered the user account.

During the creation and/or registration of the user account and/or prior to a first log into the “restaged” application, the system 100 and/or the method 200 may register the user (i.e., the first user, seller's agent, second user, buyer's agent, and/or at least one third user) and/or assign a user account to the user. The user registration may be performed, completed, and/or performed by one or more APIs associated with the system 100, the method 200, or a combination thereof. As a result, the system 100 and/or the method 200 may register the user on the “restaged” application and/or save user data/information into at least one database associated with the system 100 and/or the method 200, such as, for example, the database 110.

In at least one embodiments, at least one API may forward, transmit, and/or send a request to the user via the first device 102 and the body of the request may comprise one or more of the following user data/information: a username of the user (i.e., username); a password of the user account (i.e., password); an email of the user (i.e., email); a boolean whether the user will be a store and provide staging or not (i.e., isProvideStaging); a mobile device identification (hereinafter “ID”) to receive one or more notifications (i.e., deviceld); or any combination thereof. The response of the at least one API to the request may return one or more of the following responses: a boolean whether the request was successfully finished or there was an error (i.e., status); a status code of the response (i.e., code); a message about the response (i.e., message); data of the response (i.e., responseData); or any combination thereof. In some embodiments, the data of the response may comprise one or more of the following: a user object which has the ID, userName, email, and isProvideStaging (hereinafter “user”); a JWT token for authorization (hereinafter “Token”) which may be usable for all of the APIs to check if authorization of the request; or a combination thereof. After the user account was created and/or registered by the user, the user may log into “restaged” application via the first device 102.

At step 210, the system 100 and/or the method 200 may login the user (i.e., the first user, seller's agent, second user, buyer's agent, and/or at least one third user) into the user account of the “restaged” application. The user login may be performed, completed, and/or performed by one or more APIs associated with the system 100, the method 200, or a combination thereof. As a result, the system 100 and/or the method 200 may check and/or authorize the user to login into the “restaged” application and/or save user login data/information into at least one database associated with the system 100 and/or the method 200, such as, for example, the database 110. At least one API may forward, send, and/or transmit a request to the user via the first device 102 and a body of the request comprise one or more the following: the username of the user (i.e., userName); the password of the user account (i.e., password); the mobile device ID to receive notifications (i.e., deviceld), or a combination thereof. The response of the at least one API may return one or more of the following: a boolean whether the request was successfully finished or there was an error (i.e., status); the status code of the response (i.e., code); a message about the data response (i.e., message); the data response (i.e., responseData); or any combination thereof. In one or more embodiments, the data response may comprise one or more of the following: a user object which has the id, userName, email, and isProvideStaging (i.e., user); a JWT token for authorization (i.e., Token) which may be usable for all of the APIs to check if authorization of the request. During logging into the “restaged” application, the user may select or chose to update the information and/or data of the user account. The updated user account, updated information and/or data, or a combination thereof may be saved in the database 110 associated with the system 100 and/or the method 200.

In one or more embodiments, the system 100 and/or the method 200 may updates the user data associated with the user account of the “restaged” application. The user data update may be performed, completed, and/or performed by one or more APIs associated with the system 100, the method 200, or a combination thereof. At least one API, the system 100, and/or the method 200 may pass, send, or transmit a token in one or more request headers to verify if the user is authorized to make the request or not authorized and the at least one API may forward, send, and/or transmit a request to the user via the first device 102. In at least one embodiment, a body of the request may comprise one or more the following: the username of the user (i.e., username); the email of the user (i.e., email); a boolean whether the user will be a store and provide staging or not (i.e., isProvideStaging); a store name (i.e., storeName); a mobile number of the user (i.e., mobileNumber); an address line 1 of the user (i.e., address1); an address line 2 of the user (i.e., address2); a city where the user is located (i.e., city); a state where the user is located (i.e., state); a zipCode where the user is located (i.e., zipCode); a base64 encoded image of the user profile picture (i.e., profilePicture); or any combination thereof. A response of the at least one API to the request may comprise one or more of the following: a boolean whether the request was successfully finished or there was an error (i.e., status); a status code of the response (i.e., code); a message about the response (i.e., message); or any combination thereof. As a result, user data update may be completed, executed, and/or performed by the system 100 and/or the method 200 via the response of the at least one API to the request.

After rendering or displaying the “main page” to the seller's agent, the first device 102 may ask whether or not the seller's agent is seeking or looking to provide staging for a real estate property to subsequently be offered for sale to one or more potential buyers or buyer's agents as shown at step 235. If the seller's agent is, in fact, seeking or looking for staging items, objects, and/or furniture to stage a real estate property, the seller's agent may select “yes” and proceed to or select a “staging home” page via the first device 102 as shown at a first step 240. From the “staging home” page displayed on the first device 102, the seller's agent may utilize an AI-enhanced furniture search engine as shown at a first step 245 to determine, identify, and/or select the at least one staging item from a catalog of available staging furniture that is available to be purchased, leased, rented, or conveyed to the seller's agent. The seller's agent may select staging furniture or the at least one staging item from the catalog and the selected staging furniture or selected at least one staging item may be added to or listed within a digital shopping cart associated with the seller's agent. The first device 102 may display contents of the digital shopping cart to the seller's agents when “my cart” is selected by the seller's agent as shown at a first step 250.

In at least one embodiment, the “search furniture” option of step 245, the system 100 and/or the method 200 may search items and/or furniture associated with the user account of the “restaged” application. The items and/or furniture search may be performed, completed, and/or performed by one or more APIs associated with the system 100, the method 200, or a combination thereof. At least one API, the system 100, and/or the method 200 may search for items and/or furniture based on or associated with zipCode and radius. As a result of the search, the search result(s) may be filtered by at least one query params as follows: dateRange: (fromDate, toDate) isForRent, isForSell; categoryld; a width, height, and/or depth; color; condition; city and/or state; or any combination thereof. The system 100, the method 200, and/or the at least one API may pass, send, forward, or transmit a token when the user is logged into the “restaged” application to filter the search result(s) to avoid or not get or return any item(s) and/or furniture that belongs to or is owned by the user. A response to the request of the at least one API may comprise one or more of the following: a boolean whether the request was successfully finished or there was an error (i.e., status); a status code of the response (i.e., code); a message about or regarding the response (i.e., message); an array of objects (i.e., ResponseData); or any combination thereof. Each object may have and/or comprise at least one of the following: ID; userld; categoryld; productName color; isForSell; isForRent; productDescription; condition; width; height; depth; productSellingPrice; productDailyRentingPrice; minimumRentingPeriod; address1; address2; city; state; zipCode; productlmages; isRented; isProcured; date; nextAvailableDate; userData; and any combination thereof. As a result, the at least one API, the system 100, and/or the method 200 may display, identify, select, and/or determine one or more item(s) and/or furniture in response to the “furniture search” option via the first device 102.

In some embodiments, recently added or new staging furniture or new staging items may be displayed to the seller's agent via the first device 102 when “list new item” is selected by the seller's agent via the first device 102 as shown at step 255. The seller's agent may select one or more of the recently added or new staging furniture or new staging items and the newly selected staging furniture or staging items may be added to the digital shopping cart associated with the seller's agent. The seller's agent may review the updated digital shopping cart to confirm that the newly selected staging furniture or staging items was added to the updated digital shopping cart via a repetition of step 250. After confirming that the contents of the digital shopping cart are accurate, the seller's agent may proceed to select “orders” to place at least one order of the contents of the digital shopping cart via the first device 102 as shown at step 260. Upon placing the order of the contents of the digital shopping cart, the first device 102 may be utilized by the seller's agent to confirm that the most recently placed order and/or one or more previous orders placed by the seller's agent has/have been confirmed, shipped, delivered, and/or fulfilled by selecting “my store orders” as shown at step 265 and/or “my orders” as shown at a first step 270.

At the “orders” option of step 260, the system 100 and/or the method 200 may return one or more orders that have been made, placed, completed, or commenced by the user and/or one or more orders that that may have been requested from the user store by ID that may be provided by the JWT token. The system 100, the method 200, and/or at least one API associated with the system 100 and/or method 200 may pass, forward, send, or transmit a token in one or more request headers to verify if the user is authorized to make the request or not authorized. In at least one embodiment, a response to the request of the API may include one or more of the following: a boolean whether the request was successfully finished or there was an error (i.e., status); a status code of the response (i.e., code); a message regarding or about the response (i.e., message); responseData: having at least two arrays (i.e., userOrders and storeOrders); or any combination thereof. The at least two arrays may have or comprise one or more of the following: ID; userld; categoryld; productName; color; isForSell; isForRent; productDescription; condition; width; height; depth; productSellingPrice; productDailyRentingPrice; minimum RentingPeriod; address1; address2; city; state; zipCode; productlmages; isRented; isProcured; date; nextAvailableDate; userData associated with an object of the user data; customerData associated with an object of the customer data; orderId; storeHandshake comprising a boolean whether the store has done the handshake or not; customerHandshake comprising a boolean whether the customer has done the handshake or not; orderNumber; orderDate; orderStatus: sell or buy; status indicating pending or completed; amount; hasBeenRated comprising a boolean that represents if the user has rated this order or not; rentedFrom; rentedTo; or any combination thereof. As a result, the at least one API, the system 100, and/or the method 200 may display, identify, and/or select the returned one or more orders via the first device 102.

In one or more embodiments, the system 100 and/or the method 200 may process, enter, and/or acknowledged one or more pending orders at a user checkout via the first device 102. The system 100 and/or method 200 may proceed with checkout functionality for each item in the digital shopping cart and/or an email and/or notification may be sent to the user or customer and/or to the store with the order details. If the orderStatus is rent the whole amount of the item may be charged or billed from the user and saved into a user account with the financial service provider. If the orderStatus is sell then, for example, a discount (i.e., about 5%, about 10%, about 20%, or about 30%) of the order amount may be charged or billed from the customer or user and sent to user account with the financial service provider. In at least one embodiment, at least one API, the system 100, and the method 200 may pass, send, forward, or transmit a token in one or more request headers to verify if the user is authorized to make the request or not authorized. A body of the request may have or comprise an array of objects also referred to as items and each object/item should have or comprise one or more of the following: item Id; userld; orderStatus indicating either rent or buy; rentFrom; rentTo; address1; address2; city; state; zipCode; saveMyAddress comprising a boolean to save this address to all items or to not save; or any combination thereof. A response to the request of the API may return or comprise one or more of the following: a boolean whether the request was successfully finished or there was an error (i.e., status); a status code of the response (i.e., code); a message regarding or about the response (i.e., code); or any combination thereof. As a result, one or more pending orders may be displayed, identified, selected and/or acknowledged by the system 100 and/or method 200 via the first device 102.

In one or more embodiments, the system 100, the method 200, and/or at least one API may initiate, begin, or start a handshake process. If one of the users has no handshake done yet, the system 100 or method 200 may notify the other user and may return that waiting for the other user to handshake. If both users involved in the order may have done the handshake, then money or funds will be transferred between the users of the order, transaction, or agreement. If the orderStatus is sell then an order amount (i.e., about 60%, about 70%, about 80%, or about 100% of the order amount) will be charged or funded from the user account of the financial service provider and/or an email and/or notification may be sent to the customer and/or the store with the order details. The system 100, the method 200, and/or at least one API associated with the system 100 and/or method 200 may pass, send, forward, or transmit a token in one or more request headers to verify if the user is authorized to make the request or not authorized. A body of the request may have or comprise at least the orderId. A response to the request of the API may return or comprise one or more of the following: a boolean whether the request was successfully finished or there was an error (i.e., status); a status code of the response (i.e., code); a message regarding or about the response (i.e., message); or any combination thereof. As a result, the handshake process may be completed, acknowledged, and executed by the system 100, the method 200, and/or the at least one API and the first device 102 may display the handshake process result to the user.

After selecting to proceed with staging at step 235, the seller's agent may select “menu” via the first device 102 as shown at a first step 275. Selecting “menu” may cause the first device 102 to provide several additional selection options to the seller's agent, where the additional selection options may be based on, associated with, and/or indicative of the account, profile, store, and/or digital shopping cart of the seller's agents. For example, the additional selection options available to the seller's agent via the first device 102 after selecting “menu” may comprise at least one of the following: “my profile” as shown at step 280; “my store” as shown at step 285; “pending orders” as shown at step 290; “pay and get paid” as shown at step 295; “where do you operate” as shown at step 300; “change password” as shown at step 305; “log out” as shown at step 310; or any combination thereof. If the seller's agent selects “log out” at step 310, then the seller's agent may be prompted to be “logged in” again by returning to step 210 as shown in FIG. 2.

At the “where do you operate” option of step 300, the user may identify or set forth a geographical area, location, region, or combination thereof with respect to where the user may operate. The system 100 and/or the method 200 may display an operational location of the user via the devices 102, 104. The system 100, the method 200, or at least one API associated with the system 100 and/or method 200 may update the operational location of the user via the devices 102, 104. In at least one embodiment, the system 100, the method 200, and/or the at least one API may pass, send, forward, or transmit a token in one or more request headers to verify if the user is authorized to make the request or not authorized. A body of the request may have or comprise one or more of the following: an array of objects and each object may represent the zipCode and the radius of the area that the user store will be available at or operate within (i.e., area). A response to the request of the at least one API may return or comprise one or more of the following: a boolean whether the request was successfully finished or there was an error (i.e., status); a status code of the response (i.e., code); a message regarding or about the response (i.e., message); or any combination thereof. As a result, the operational location of the user may be determined, identified, selected, or acknowledged by the system 100, the method 200, and/or the at least one API. Further, the optional location of the user may be displayable via the devices 102, 104.

At the “change password” option of step 305, the system 100 and/or the method may change, update, or overwrite the password associated with the user account. The system 100 and/or method 200 may change and/r update the user password after verifying that the old user password is the same as the old user password stored within a database associated with the system 100 and/or method 200 (i.e., the database 110). In at least one embodiment, the system 100, the method 200, and/or at least one API associated with the system 100 and/or method 200 may pass, send, forward, and/or transmit a token in one or more request headers to verify if the user is authorized to make the request or not authorized. A body of the request may have or comprise one or more of the following: the user old password (i.e., oldPassword); a new password that the user wants to set (i.e., newPassword); or a combination thereof. A response to the request of the API may return or comprise one or more of the following: a boolean whether the request was successfully finished or there was an error (i.e., status); a status code of the response (i.e., code); a message regarding or about the response (i.e., message); or any combination thereof. As a result, the system 100 and/or the method 200 may change or update the user password associated with the user account via the devices 102, 104.

In one or more embodiments, the system 100 and/or the method 200 may reset the password associated with the user account. As a result, the system 100 and/or method 200 may reset or rewrite user password with a new password. A body of the request from at least one API associated with the system 100 and/or method 200 may have an email and a new password for the user account. A response to the request of the API may return or comprise one or more of the following: a boolean whether the request was successfully finished or there was an error (i.e., status); a status code of the response (i.e., code); a message regarding or about the response (i.e., message); or any combination thereof. As a result, the password of the user account may be reset and new password may be acknowledged by the system 100 and/or the method 200 via the devices 102, 104.

In one or more embodiments, the system 100 and/or the method 200 may verify a password reset regarding the password associated with the user account. The system 100, method 200, or at least one API associated with the system 100 and/or method 200 may sends an email to verify reset password and/or a body of the request may have or comprise the email. A response to the request of the API may return or comprise one or more of the following: a boolean whether the request was successfully finished or there was an error (i.e., status); a status code of the response (i.e., code); a message regarding or about the response (i.e., message); or any combination thereof. As a result, the system 100 and/or method 200 may verify the password reset and the password reset verification may be displayed via the device 102, 104.

In some embodiments, the “my profile” option may have been selected by the seller's agent via the first device 102 as shown at step 280. Subsequently to selecting the “my profile” option, the seller's agent may be prompted to indicate whether or not staging is desirable via the first device 102 as shown at step 315. If staging is desirable or to be provided to the seller's agents, the seller's agent may be returned to the “provide staging” inquiry at step 235.

At the “my profile option” of step 280, the system 100 and/or the method 200 may return, display, or acknowledge user data by ID which will be provided by the JWT token. The system 100, the method 200, and/or at least one API associated with the system 100 and/or method 200 may pass, send, forward, and/or transmit a token in one or more request headers to verify if the user is authorized to make the request or not authorized. A response to the request of the at least one API may return or comprise: a boolean whether the request was successfully finished or there was an error (i.e., status); a status code of the response (i.e., code); a message regarding or about the response (i.e., message); an objection (i.e., responseData); or any combination thereof. In at least one embodiment, the object may have or comprise one or more of the following: ID; username; email; mobileNumber; storeName; rate; numberOfUsersRated; address1; address2; city; state; zipCode; isProvideStaging; profilePicture; an array that may represents where the user is operating (i.e., userOperationLocation); hasStripeConnectAccount; hasCard; or any combination thereof. As a result, the user data may be displayed via the devices 102, 104 and/or accessible via the system 100 and/or the method 200.

Further, the “my store” option may have been selected by the seller's agent via the first device 102 as shown at step 285. Subsequently to selecting the “my store” option, the seller's agent may be prompted to the “list new item” at step 255, wherein the one or more of the recently added or new staging furniture or new staging items are displayable and/or selectable again by the seller's agent and any newly selected staging furniture or staging items may be added to the updated digital shopping cart associated with the seller's agent. Still further, after selection of the “my store” option at step 285, the seller's agent may utilize the first device 102 to select at least one of “my items” as shown at step 320, “store dashboard” as shown at step 325, or a combination thereof.

At the “my store” option of step 285, the system 100 and/or the method 200 may determine, identify, or acknowledge if the user desires or prefers to stage at least one real estate property via the devices 102, 104. If staging is desirable or preferred, the system 100 and/or method 200 may add at least one item and/or furniture to the user store. The system 100, the method 200, and/or at least one API associated with the system 100 and/or method 200 may pass, send, forward, and/or transmit a token in one or more request headers to verify if the user is authorized to make the request or not authorized. A body of the request may have or comprise one or more the following: categoryld; productName; color; isForSell; isForRent; productDiscription; condition; width; height; depth; productSellingPrice; productDailyRentingPrice; minimumRentingPeriod; address1; address2; city; state; zipCode; an array of base64 encoded images (i.e., productlmages); or any combination thereof. A response to the request of the API may return or comprise one or more of the following: a boolean whether the request was successfully finished or there was an error (i.e., status); a status code of the response (i.e., code); a message regarding or about the response (i.e., message); responseData indicative of returning the ID number; or a combination thereof. As a result,

At the “my items” option of step 320, the system 100 and/or the method 200 may identify, determine, return and/or display the user data based on or associated with the ID that may be provided by the JWT token via the devices 102, 104. The system 100, the method 200 and/or at least one API associated with the system 100 and/or the method 200 may pass, send, forward, and/or transmit a token in one or more request headers to verify if the user is authorized to make the request or not authorized. A response to the request of the at least one API may return or comprise one or more of the following: a boolean whether the request was successfully finished or there was an error (i.e., status); a status code of the response (i.e., code); a message regarding or about the response (i.e., message); an object (i.e., responseData; or any combination thereof. In at least one embodiment, the object may have or comprise one or more of the following: ID; username; email; mobileNumber; storeName; rate; numberOfUsersRated; address1; address2; city; state; zipCode; isProvideStaging; profilePicture; an array that may represent where the user is operating (i.e., userOperationLocation); hasStripeConnectAccount; hasCard; or any combination thereof. As a result, the user data may be identified, return, determined, and/or acknowledged by the system 100 and/or the method 200 and the user data may be displayable via the devices 102, 104.

At the “store dashboard” option of step 325, the system 100 and/or the method 200 may identify, determine, return, and/or acknowledge statistics associate with the user, the user account and/or user store. In some embodiments, the system 100 and/or method 200 may identify, determine, return, and/or acknowledge store statistics of total buys, total rents, and total number of orders. The system 100, the method 200, and/or at least one API associate with the system 100 and/or method 200 may pass, send, forward, and/or transmit a token in one or more request headers to verify if the user is authorized to make the request or not authorized. The request may include a date range within the following request params: from Date; toDate; or a combination thereof. If the range was passed, the system 100 and/or method 200 may return the stats between these days. If the range was not passed, then the system 100 and/or method 200 may return the lifetime statistics. A response to the request of the API may return or comprise one or more of the following: a boolean whether the request was successfully finished or there was an error (i.e., status); a status code of the response (i.e., code); a message regarding or about the response (i.e., message); response data (i.e., responseData); or any combination thereof. The response date may have or comprise one or more of the following: total money that was earned from selling products (i.e., totalSales); total money was earned from renting products (i.e., accruedRent); a number of products that the store has provided (i.e., products). As a result, the system 100 and/or the method 200 may determine, identify, or acknowledge one or more statistics associate with the user, the user account and/or user store and the one or more statistics may be displayable via the devices 102, 104.

The system 100, the method 200, and/or at least one API associated with the system 100 and/or method 200 may send, forward, or transmit an email to verify reset password. A body of the request may have or comprise the email and the response to the request of the API may return or comprise one or more of the following: a boolean whether the request was successfully finished or there was an error (i.e., status); a status code of the response (i.e., code); a message regarding or about the response (i.e., message); or any combination thereof. As a result, the reset password verification may be displayable via the devices 102, 104.

In some embodiments, the system 100, the method 200, and/or the at least one API associated with the system 100 and/or methods may return, identify, determine, and/or acknowledge fees for each item in the request body. The system 100, the method 200 and/or the at least one API may pass, send, forward, and/or transmit a token in one or more request headers to verify if the user is authorized to make the request or not authorized. A body of the request may have or comprise an items array, wherein each item may have or comprise one or more of the following: item Id; itemStatus; rentFrom; rentTo; or any combination thereof. A response to the request of the API may return or comprise: a boolean whether the request was successfully finished or there was an error (i.e., status); a status code of the response (i.e., code); a message regarding or about the response (i.e., message); data response (i.e., responseData); an array of objects; or any combination thereof. In an embodiment, each object of the array may have or comprise one or more of the following: item Id; item Fees; or a combination thereof. As a result, the returned, identified, determined, and/or acknowledged fees may be displayable via the devices 102, 104.

In one or more embodiments, the system 100 and/or the method 200 may return, determine, identify, and/or acknowledge one or more dates that an item was rented at by item ID for an item calendar. The system 100, the method 200, and/or at least one API associated with the system 100 and/or the method 200 may pass, send, forward, and/or transmit a token in one or more request headers to verify if the user is authorized to make the request or not authorized. A body of the request may have or comprise the item Id and a response to the request of the API may return or comprise one or more of the following: a boolean whether the request was successfully finished or there was an error (i.e., status); a status code of the response (i.e., code); a message regarding or about the response (i.e., message); data response comprising an array of objects (i.e., responseData); or any combination thereof. Each object of the array may have or comprise one or more of the following: an object that has the customer data (i.e., customerData); rentedFrom; rentedTo; or any combination thereof. As a result, the returned, determined, identified, and/or acknowledged one or more dates for the rented item(s) may be displayable via the devices 102, 104.

In some embodiments, the system 100 and/or the method 200 may return, determine, identify, or acknowledge one or more statistics of at least one item by ID. The system 100, the method 200, and/or at least one API associated with the system 100 and/or the method 200 may pass, send, forward, and/or transmit a token in one or more request headers to verify if the user is authorized to make the request or not authorized. A request query params may have or comprise itemId and/or a response to the request of the API may return or comprise one or more of the following: a boolean whether the request was successfully finished or there was an error (i.e., status); a status code of the response (i.e., code); a message regarding or about the response (i.e., message); response data comprising an array of objects (i.e., responseData); or any combination thereof. Each object of the array may have or comprise one or more of the following: an object that has the customer data (i.e., customerData); rentedFrom; rentedTo; revenue; or any combination thereof. As a result, the returned, determined, identified, or acknowledged one or more statistics of the at least one item may be displayable via the devices 102, 104.

In at least one embodiment, after selection of the “pending orders” option at step 290, the system 100 and/or the method 200 may return, determine, identify, and/or acknowledge at least one order where its status is pending or has not been rated by a user ID that may be provided by the JWT token. The system 100, the method 200, and/or at least one API associated with the system 100 and/or method 200 may pass, send, forward, and/or transmit a token in one or more request headers to verify if the user is authorized to make the request or not authorized. A response to the request of the API may return or comprise: a boolean whether the request was successfully finished or there was an error (i.e., status); a status code of the response (i.e., code); a message regarding or about the response (i.e., message); response data comprising an array of objects; or any combination thereof. Each object of the array may have or comprising one or more of the following: ID; userld; categoryld; productName; color; isForSell; isForRent; productDescription; condition; width; height; depth; productSellingPrice; productDailyRentingPrice; minimum RentingPeriod; address1; address2; city; state; zipCode; productlmages; isRented; isProcured; date; nextAvailableDate; an object of the user data (i.e., userData); an object of the customer data (i.e., customerData); orderId; a boolean whether the store has done the handshake or not (i.e., storeHandshake); a boolean whether the customer has done the handshake or not (i.e., customerHandshake); orderNumber; orderDate; orderStatus comprising sell or buy; status comprising pending or completed; amount; a boolean that represents if the user has rated this order or not (i.e., hasBeenRated); rentedFrom; rentedTo; or any combination thereof. As a result, the returned, determined, identified, or acknowledged one or more statistics of the at least one item may be displayable via the devices 102, 104.

In some embodiments, after selection of the “pay and get paid” option at step 295, the system 100 and/or the method 200 may add at least one user card to stripe and/or save the user card ID that returns from stripe into a database associated with the system 100 and/or method 200. The system 100, the method 200, and/or at least one API associated with the system 100 and/or method 200 may pass, send, forward, and/or transmit a token in one or more request headers to verify if the user is authorized to make the request or not authorized. A body of the request may have or comprise one or more of the following: cardNumber; expireMonth; expireYear; cvv; a boolean whether the user will use his same address or will provide a different address for the card (i.e., useCurrentLocation); address1; address2; city; state; zipCode; cardHolderName; or any combination thereof. A response to the request of the API may return or comprise: a boolean whether the request was successfully finished or there was an error (i.e., status); a status code of the response (i.e., code); a message about the response (i.e., message); or any combination thereof. As a result, the added at least one card may be displayable via the devices 102, 104.

In one or more embodiments, the system 100 and/or the method 200 may connect at least one financial account to the users account and/or create at least one link that redirects the user to stripe to start onboarding the user. The system 100, the method 200, and/or at least one API associated with the system 100 and/or the method 200 may pass, send, forward, and/or transmit a token in one or more request headers to verify if the user is authorized to make the request or not authorized. A response to the request of the API may return or comprise: a boolean whether the request was successfully finished or there was an error (i.e., status); a status code of the response (i.e., code); a message regarding or about the response (i.e., message); response data comprising at least one link that the financial service provide may provide for onboarding users (i.e., responseData); or any combination thereof. As a result, connected or created financial account and/or link is displayable via the devices 102, 104.

The system 100 and/or the method 200 may rate the user of the “restaged” application based on or indicative of the user usage of the “restaged” application. The system 100, the method 200, and/or at least one API associated with the system 100 and/or method 200 may pass, send, forward, and/or transmit a token in one or more request headers to verify if the user is authorized to make the request or not authorized. In at least one embodiment, a body of the request may have or comprise one or more of the following: an achieved total score from a possible total score, such as, for example, 25 (i.e., userRate); the ID of the user that will be rated (i.e., userld); the id of the order that the user will rate the user for (i.e., orderId); or any combination thereof. A response to the request of the API may return or comprise one or more of the following: a boolean whether the request was successfully finished or there was an error (i.e., status); a status code of the response (i.e., code); a message regarding or about the response (i.e., message); or any combination thereof. As a result, the assigned, achieved, or determined rating of the user may be displayable via the devices 102, 104.

In one or more embodiments, the system 100 and/or the method 200 may return, determine, identify, and/or acknowledge user card data from financial service provider by card ID. The card ID may be retrieved from a database (i.e., the database 110) by the user ID which may be provided by the JWT token. The system 100, the method 200, and/or at least one API associated with the system 100 and/or method 200 may pass, send, forward, and/or transmit a token in one or more request headers to verify if the user is authorized to make the request or not authorized. A response to the request of the API may return or comprise one or more of the following: a boolean whether the request was successfully finished or there was an error (i.e., status); a status code of the response (i.e., code); a message regarding or about the response (i.e., message); response data (i.e., responseData); or any combination thereof. In at least one embodiment, the response data may have or comprise one or more of the following: cardLastFourDigits; cardExpirationMonth; cardExpirationYear; cardHolderName; or any combination thereof. As a result, the returned, determined, identified, and/or acknowledged user card data may be displayable via the devices 102, 104.

Alternatively, to selecting “yes” at the staging inquiry shown at step 235, the seller's agent may utilize the first device 102 to select “no” in response to whether or not staging is to be provided to the seller's agent. After selection of the “no” option at step 235, the seller's agent may select one or more of the following additional selection options: “home” as shown at a second step 240; “my cart” as shown at a second step 250; “my orders” as shown at a second step 270; “menu” as shown at a second step 275; or any combination thereof. In an embodiment, the first steps 240, 250, 270, and 275 may be the same step or substantially the same step as second steps 240, 250, 270, and 275, respectively. Additionally, upon selection of the “menu” option at second step 275, the seller's agent my utilize the first device 102 to select one or more of the additional selection options selected from: the “my profile” option of step 280; the “my store” option of step 285; the “pending orders” option of step 290; the “pay and get paid” option of step 295; the “where do you operate” option of step 300; the “change password” option of step 305; the “log out” option of step 310; or any combination thereof. Moreover, after selection of the “home” option of second step 240, the seller's agent may utilize an AI-enhanced furniture search engine as shown at a second step 245 to determine, identify, and/or select the at least one staging item from a catalog of available staging furniture that is available to be purchased, leased, rented, or conveyed to the seller's agent. In an embodiment, the second step 245 may be same step or substantially the same step as first step 245.

Examples of the present systems, methods, and applications disclosed herein may also be directed to a non-transitory computer-readable medium that stores computer-executable instructions and/or the AI software 120, which are executable by one or more processors of at least one of the devices 102, 104, the server 108, and/or the interface 112 from which the computer-readable medium is accessed. A computer-readable media may be any available media that may be accessed by at least one of the devices 102, 104, the server 108, and/or the interface 112. By way of example, such computer-readable media may comprise RAM, ROM, EEPROM, CD-ROM or other optical disk storage, magnetic disk storage or other magnetic storage devices, or any other medium that may be used to carry or store desired program code in the form of computer-executable instructions, the AI software 120, and/or data structures and that may be accessed by at least one of the devices 102, 104, the server 108, and/or the interface 112. Disk and disc, as used herein, includes compact disc, laser disc, optical disc, digital versatile disc, floppy disk and Blu-ray® disc where disks usually reproduce data magnetically, while discs reproduce data optically with lasers.

Note also that the software implemented aspects of the present systems, methods, and applications disclosed herein are usually encoded on some form of program storage medium or implemented over some type of transmission medium. For example, the software 120 may be encoded on a form of program storage medium or implemented over a type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

In at least one embodiment, the present systems, methods, and application disclosed herein may be opened, started, initiated, or selected by a user (i.e., the first users, second user, seller's agent, buyer's agent, and/or one or more third users) via at least one device of the devices 102, 104. Upon opening via the at least one device, the user may be met with a white or non-white background and/or the following text: “Welcome To Staged,” which may be displayed as/in crisp non-white or black letters. The background and/or text may fade or disappear and/or the user may be asked to choose between at least the following questions/inquires: “I have furniture to rent”, “I have furniture to sell”, “I need furniture to rent”, or “I need to purchase furniture”.

In some embodiments, the system 100 and/or the method 200 may provide or facilitate one or more secure transactions and/or waivers. For example, the user may be asked at least one of the following questions/inquires: “It asks are you a realtor?”, “Seller?” or “Professional Stager?”. If the user is a realtor or a professional stager, the “restaged” application may ask the user for at least one professional license number associated with or assigned to the user. In contrast, a user that is a seller may automatically move onto one or more further questions/inquires and/or options provided by the “restaged” application. In an embodiment, the professional license number may facilitate or allow the AI software 120 and/or the AI-based hardware 122 to provide or offer at least one link to one or more real estate listings with the staged profile of the user associated with the at least one professional license number. The user may be asked to sign or execute a “Covid Hold Harmless” form agreeing to the one or more terms and/or one or more conditions for conducting business with the “restaged” application (i.e., must sanitize furniture, must agree to fair trade, must agree that what the user is presenting is as such, and/or etc.). Once entered or logged into the “restaged” application or website, the user may be greeted with an easy application-based or web-based interface and/or may begin listing, selling, trading the at least one staging item and/or one or more pieces of staging furniture via the “restaged” application or website.

After initiating the “restaged” application or website, the user may select at least one path for utilizing the services and/or functionality of the systems, methods, and applications disclosed herein. Upon selection of a first path by the user, the system 100 and/or the method 200 may provide functionality for the user to stage at least one real estate property that may be subsequently offered for sale or rental/lease by the user. For example, the “restaged” application or website may identify “Path 1” as a user that is “Looking To Stage” a real estate property via the system 100 and/or the method 200. When the first path is selected by the user, the system 100 and/the method 200 may ask the user which real estate property listing is to be staged. In an embodiment, the system 100 and/or the method 200 may identify the real estate property to be staged based on user input into the at least one device of the devices 102, 104 and/or may automatically populate at least one form associated with the “restaged” application or website via information/data provided by and/or accessible from a local MLS IDX feed. In at least one embodiment, the present systems, methods, and applications disclosed herein may be in communication with at least one real-time or live digital data feed that may comprise at least one local MLS IDS feed.

If the real estate property to be staged by the user (i.e., seller's agent or realtor) is a new real estate listing, then the system 100 and/or the method 200 may prompt the user to provide and/or input or submit at least the physical address of the new real estate listing coming to or being added to the real estate market. Then, the system 100 and/or method 200 may ask the user when the user may need the at least one staging item and/or furniture for staging the new real estate listing. Further, the system 100 and/or the method 200 may ask the user whether the user is looking, seeking, or desiring to rent, lease, or buy the at least one staging item and/or staging furniture. Still further, the system 100 and/or the method 200 may ask the user what room(s) are to be staged with the at least one staging item and/or staging furniture. In one or more embodiments, the room(s) to be staged may be or may include one or more of the following: a living room, a bedroom, a kitchen, a dining room, a family room, a guest room, a bathroom, a game room, a basement, a home office, a nursery, a playroom, a library, a storage room, a gym room, a loft, an attic, or any combination thereof. The present disclosure should not be deemed as limited to a specific embodiment of the room(s) to be staged via the systems, methods, and/or applications disclosed herein.

The “restaged” application or website provided by the system 100 and/or the method 200 may allow the user to determine, identify, select, and/or confirm one or more types of staging furniture for staging the real estate listing and whether the user is looking, seeking, or desiring to swap or exchange one or more of the selected staging items and/or staging furniture. Additionally, the system 100 and/or the method 200 may ask how far the user may be willing to travel or to go for obtaining and/or receiving one or more of the selected staging items and/or staging furniture. An acceptable mileage radius, which may include or comprise at least one specific town or zip code(s), may be identified, determined, selected, and/or confirmed by the user via the “restaged” application or website and/or the system 100 and/or the method 200 may list one or more available staging items and staging furniture based upon the acceptable milage radius. The system 100 and/or the method 200 may generate, provide, display, and/or render the listed one more available staging items and furniture with at least one of the following: corresponding pricing(s), corresponding owner(s), corresponding owner rating(s)/review(s), or any combination thereof. In an embodiment, the system 100 and/or the method 200 may not provide contact information of the corresponding owner(s) to protect profit generation of the “restaged” application or website.

In one or more embodiments, the system 100 and/or the method 200 may identify, display, and/or render all item availability dates to the user such that the user may see which availability dates may be more or most desirable. Additionally, based on the listed one or more staging items and furniture and/or availability dates, the user may add at least one listed staging item and/or furniture to the digital shopping cart of the user account associated with the user. The digital shopping cart may be ordered by the user via the “restaged” application or website and then said digital shopping cart order may be subsequently reviewed by the user and/or the digital shopping cart order may be placed by the user via the system 100 and/or the method 200. Further, the cost(s)/fee(s) associated with the placed digital shopping cart order may be paid by the user via the user account over the “restaged” application or website. In at least one embodiment, a staged transaction fee may be applied to the placed digital shopping cart order prior to charging the financial service provider account associated with the user account over the “restaged” application or website. Once the cost(s)/fee(s) associated with the placed digital shopping cart order has been agreed to or upon by the user, the user may then close out or complete the transaction over the “restaged” application or website. As a result, contact information for the supplier of the ordered staging item(s) and/or furniture may be provided to the user via the system 100 and/or the method 200, and/or the user may arrange a time to meet/discuss the placed order and/or transaction with the supplier via the “restaged” application or website. In at least one embodiment, one or more approved local movers may be suggested by the “restaged” application or website for aiding or helping the user and supplier with the transfer of ordered staging item(s) and furniture at a separate cost/fee. In an embodiment, the separate cost/fee may also be charged to the user account of the “restaged” application or website as an additional or further transaction fee.

Upon selection of at least one second path by the user, the system 100 and/or the method 200 may provide functionality for the user to stage at least one real estate property that may be subsequently offered for sale or rental/lease by the user. For example, the “restaged” application or website may identify at least one “Path 2” as a user that is “Looking To Sell/Rent Staged Furniture” for staging at least one real estate property via the system 100 and/or the method 200. If the user may be looking, seeking, or desiring to sell, rent, or lease at least one staging item or furniture, then the system 100 and/or the method 200 may asked the user to upload or transfer one or more digital photographs and/or details associated with and/or indicative of each staging item or furniture. In at least one embodiment, the details of the staging item(s) or furniture may comprise, but is not limited to, at least one name, at least one physical description, at least one material of the staging item or furniture, one or more dimensions, at least one style, at least one condition, or any combination thereof. The present disclosure should not be deemed as limited to the specific embodiment of the details associated with or indicative of the one or more staging items or furniture.

In one or more embodiments, the staging item(s) or furniture may be currently used in staging at least one real estate listing and/or the “restaged” application or website may allow the user or realtor to provide at least one digital link to digital listing information associated with the currently staged real estate listing. The system 100 and/or the method 200 may ask the user to provide or share when the staging item(s) or furniture may subsequently be available for further staging and if the staging item(s) or furniture may be for rent, lease or sale. If the staging item(s) or furniture is listed “for rent”, then a preferred mileage radius may be selected (which may include one or more specific towns or at least one specific zip code) and/or the system 100 and/or method 200 may identify, determine, provide, or generate a list of available staging items and furniture with at least one of a corresponding pricing, a corresponding owner(s), a corresponding owner rating(s)/review(s), or any combination thereof. In an embodiment, the “restaged” application or website may not provide contact information to protect profit generation of the “restaged” application or website.

Once the staging item(s) or furniture is uploaded and properly described over the “restaged” application or website, the user or realtor may select or click “bring to market” link to publish the uploaded/described staging item(s) or furniture. If another user or community member selects the uploaded/described staging item(s) or furniture prior to charging the other user or community member, at least one transaction fee may be applied by the “restaged” application or website. Once agreed to the buying/renting user or agent may then close out the transaction and/or contact information for the buyer/renter user may be provided over the system 100 and/or method 200 and the buy/renter user may arrange a time to meet/discuss the move and/or transaction of the staging item(s) or furniture. In at least one embodiment, one or more approved movers may be suggested via the system 100 and/or the method 200 for aiding or helping the user(s) with the transfer of the ordered staging item(s) or furniture. At least one separate cost may also be charge via the “restaged” application or website with respect to the movers and/or moving company as an additional transaction fee.

In one or more embodiments, the system 100 and/or method 200 may have or comprise one or more required listing fields with respect to the available staging item(s) or furniture to be offered for rent, lease, or sale by the user for subsequent staging of at least one real estate listing or the like. For example, if the available staging item(s) or furniture is to be listed as “rented” or “leased” items or furniture, then the “restaged” application or website may direct the renter/leaser user to a digital page that requests one or more of the following: type of furniture; age of product; brand; dimensions; color; material; condition; duration of rental; availability date; asking price; pickup location; pickup time; location where staging item or furniture may be held; terms of use agreement clearly stating if damaged the security deposit withheld; or any combination thereof.

The “restaged” application or website facilitated or provided by the system 100 and/or the method 200 may also comprise one or more monetization opportunities and/or avenues. For example, the “restaged” application may be a free downloadable smartphone application and/or registration and membership to the “restaged” application may also be free to its members (i.e., the first user(s), the second user(s), the seller's agent(s), buyer's agent(s), and/or one or more third users). In an embodiment, the “restaged” application is free to download from a known/available application store and is also free to join on smartphones, mobile computing devices, AI-enhanced computing devices, AI-enable cloud computing devices, smart wearable devices, and/or ARNR-based computing devices. Upload or adding one or more staging items and/or furniture to the user accounts may be free for its members and transaction fees may be a percentage based off of each transaction paid for by the buyer/renter. In at least one embodiment, the “restage” application or website may comprise one or more of the following additional streams of income: a first additional income stream associated with one or more moving company partnerships (i.e., upon being hired, a transaction fee is applied); a second additional stream associated with one or more professional staging design services (i.e., upon being hired, a finder's fee is applied); a third additional steam associated with goods/services facilitated by the “restaged” application or website; or any combination thereof.

In one or more embodiments, the user (i.e., a seller and/or owner of a real estate listing) may seek, want, or desire to highlight its staged rooms and/or available staging furniture. Said user may pay a predetermined or specific fee to have its staged rooms and/or available staging furniture highlighted in a “CENTER STAGE” section of the “restaged” application or website. In a further effort to move unwanted pieces (i.e., staging items and/or staging furniture), the user (i.e., a seller and/or owner of a real estate listing) may pay to hard sell its staging items and/or furniture listed in an “EXIT STAGE LEFT” section of the “restaged” application or website that showcases best deals presented by the user (i.e., seller/owner of the real estate listing). Moreover, the user may add or integrate one or more advertisements into the platform provided by the “restaged” application or website for additional commercial goods/services, such as, for example, one or more landscapers, one or more cleaning services, one or more mortgage brokers, any combinations thereof, and/or the like. The additional commercial goods/services may advertise directly to the user or agents without wasting additional time associate with advertising on other platforms outside of the platform provided by the “restaged” application or website.

In at least one embodiment, the “restaged” application or website may comprise one or more of the staged application levels: an “UPSTAGED” level for luxury higher end items typically more expensive and for higher end properties and their corresponding budgets; a “CENTER STAGE” level for user items to appear more frequently and at the top of the search page (i.e., one or more sellers/owners may pay extra for this service); an “EXIT STAGE LEFT” level for items that may not seem to be rented or sold or need to be moved quickly (i.e., one or more sellers/owners may pay an extra fee to have said items appear in the clearance section); or any combination thereof. In some embodiments, the “restaged” application or website may provide one or more of the following digital services for buyer users or renter users: providing an efficient platform for local trade; providing automatic alerts at intervals (i.e., two weeks, one week, three days, and the day before) to remind the user; tracking all inventory (i.e., digitally showcasing what listing has what, for how long, where, and at what price); providing one or more tables showcasing the total spent each month/year for easy tax filing; providing one or more buyer/renter reviews; connecting users with movers, moving companies, designers, and other industry personnel; or any combination thereof.

In some embodiments, the present systems, methods, and applications disclosed herein may comprise one or more AI-based or AI-enhanced components (i.e., the AI software 120 and/or the AI-based hardware 122). For example, the system 100 and/or method 200 facilitating the “restaged” application or website may comprise or utilize the one or more AI-based or AI-enhanced components. For example, the system 100 and/or method 200 may provide local MLS integration with the one or more AI-based or AI-enhanced components. As a result of the local MLS integration, the user or agent may list one or more new real estate listings and be prompted with at least one text and/or instant message asking if the user or agent if staging the one or more new listings is necessary, required, and/or desirable. The “restaged” application may be a mobile-based application for easy adaptation to facilitate the transmission of the at least one text and/or instant message. Further, when a new real estate listing may go into contract, the “restaged” application may alert users of staging furniture that may be sold/given back soon and/or may send owner information (i.e., owner of the staging furniture) to the users of the “restaged” application. Once a member (i.e., user, realtor, seller's agent, etc.) may list a new real estate listing, the “restaged” application may showcase the new real estate listing on a digital map and/or identify a closest staging furniture with respect to the geographical location of the new real estate listing for easy moving the closest staging furniture. The member (i.e., renter/buyer of the staging furniture) may optionally select each location and cycle through the available staging furniture, availability dates for the available staging furniture, or a combination thereof.

In one or more embodiments, the present systems, methods, and applications disclosed herein provide at least one of virtual reality (hereinafter “VR”) home staging, augmented reality (hereinafter “AR”) home staging, or a combination thereof. The VR home staging and/or AR home staging (collectively referred to hereinafter as “VR/AR staging”) is provided, created, generated, and/or facilitated via at least one of the AI software 120, the AI-based hardware 122, or a combination thereof. The present VR/AR staging provides 2D and/or 3D digital designs of staged interior spaces, rooms, and/or areas of at least one real estate listing. At least one graphic digital editor may be utilized by the AI software 120 and/or the AI-based hardware 122 to create, generate, and render the digital design of the at least one real estate listing. The VR/AR staging provides, creates, generates, and/or displays a digital visualization of the real estate listing comprising digital staged interior spaces, rooms, and/or areas of the real estate listing. The VR/AR staging may be provided for one or more vacant real estate properties such that the AI software 120 and/or AI-based hardware 122 generates, creates, and/or simulates digitally staged interior spaces, rooms, and/or areas of the vacant real estate properties.

In at least one embodiment, the AI software 120 and/or AI-based hardware 122 comprises and/or utilizes one or more data analysis algorithms to generate, create, and/or simulate the VR/AR staging comprising staged interior spaces, rooms, and/or areas of the real estate listing. The AI software 120, the AI-based hardware, and/or the one or more data analysis algorithms may scan, analyze, evaluate, and/or manipulate a plurality of digital images to generate, create, and/or simulate the VR/AR staging of the real estate listing. The VR/AR staging may also comprise, display, render, or includes at least one of at least one interior model, at least one décor model, or a combination thereof for staging the real estate listing. The at least one interior model and/or décor model may consist of the digitally staged interior spaces, rooms, and/or areas of the real estate listing. In an embodiment, the plurality of digital images may comprise one or more non-professional photographs/images, one or more professional photographs/images, one or more stock photographs/images, one or more references photographs/images, one or more product, item, and/or furniture photographs/images, one or more uploaded photographs/images, or any combination thereof. The plurality of digital images may comprise one or more high-quality photos illustrating one or more residential, dwelling, decorative, and/or furniture styles. The one or more styles may comprise one or more of the following styles: classic; contemporary, European; gothic; industrial; modern; rural; urban; Scandinavian; Victorian; beach house; farmhouse; or any combination thereof.

The VR/AR staging of the real estate listing may be accessed by one or more users of the present systems, methods, and applications disclosed herein (i.e., at least one of the system 100 and method 200). Moreover, the VR/AR staging created, generated, simulated, and/or provided by the system 100 and/or method 200 may be displayable, viewable, and/or rendered via at least one device of the devices, 102, 104. In at least one embodiment, at least one user of the “restage” application or website may digitally drag and drop at least one staging item and/or staging furniture into one or more virtual rooms associated with the real estate listing via at least one device of the devices 102, 104. The VR/AR staging of the real estate listing may be generated, created, simulated, and/or provided via the “restage” application or website by digital dragging and/or dropping the at least one staging item and/or staging furniture into the one or more virtual rooms accessible over the devices 102, 104.

In at least one embodiment, the VR/AR staging created, generated, and/or simulated by the AI software 120 and/or AI-based hardware 122 may comprise one or more video, one or more spherical photographs/images, one or more window-view photographs/images, one or more 2D and/or 3D floorplans of VR/AR staged real estate listing, or any combination thereof. In an embodiment, the one or more videos may comprise at least one flyover video and/or the spherical and window-view photographs may be angled photographs, such as, 360° or 180° photographs. Moreover, the VR/AR staging of the real estate listing may create, generate, produce, or provide at least one live view of a real-world environment of the digitally staged real estate listing wherein on or more of the real estate elements may be augmented by at least one computer-generated sensory input generated by the AI software 120 and/or AI-based hardware 122. In an embodiment, the VR/AR staging may provide at least one virtual and/or augmented staging solution for one or more commercial spaces or properties.

In one or embodiments, VR/AR staging of the method 200 may comprise at least one first step wherein the AI software 120 and/or AI-based hardware 122 may select one or more digital images to stage the real estate property via the one or more data analysis algorithms and/or computer-generated sensory inputs associated with the AI software 120 and/or AI-based hardware 122. As a result, the AR/AR staging of the real estate listing may display or render one or more 3D photographs and/or one or more virtual tours that are viewable over the devices 102, 104, the “restaged” application or website, or a combination thereof. In embodiment, the at least one first step may comprise selecting one or more digital images, one or more digital staging furniture images, one or more design element images, or any combination thereof for the VR/AR staging of the real estate property. The method 200 may also comprise one or more additional steps, wherein the AI software 120 and/or AI-based hardware 122 may select one or more digital staging furniture images to stage the real estate property via the one or more data analysis algorithms and/or computer-generated sensory inputs associated with the AI software 120 and/or AI-based hardware 122. As a result, one or more digital photographs/images may be provided to the user of the “restaged” application or website via the devices 102, 104. In an embodiment, the digital staging furniture may be grouped by furniture styles, room types, time periods, design elements/features, or any combination thereof. Moreover, the method 200 may comprise one or more further steps, wherein the system 100 (i.e., at least one of the AI software 120 and/or AI-based hardware 122) and/or method 200 may generate, produce, and/or create a final VR/AR staged real estate listing via the one or more data analysis algorithms and/or computer-generated sensory inputs associated with the AI software 120 and/or AI-based hardware 122. As a result, the final AR/AR staged real estate listing may be displayed, rendered, and/or viewable over the devices 102, 104, the “restaged” application or website, another digital device in digital communication with the system 100 or incorporated into method 200, or any combination thereof.

In at least one embodiment, the one or more digital photographs/images, the final VR/AR staged real estate listing, or a combination thereof may be receivable over the devices 102, 104, download to the devices 102, 104 and/or from the database 110 over the system 100 via the method 200, accessible over the system 100 via the method 200, or any combination thereof. In an embodiment, the system 100 and/or method 200 may create, generate, and/or provide at least one digital tour link for viewing and/or displaying the one or more digital photographs/images, the final VR/AR staged real estate listing, the one or more virtual tours, or any combination over the system 100 via the method 200. A digital 3D player may be incorporated into the system 100 and/or method 200 such that the one or more digital photographs/images, the final VR/AR staged real estate listing, and/or the one or more virtual tours is displayable over the devices 102, 104 via the digital 3D player, the system 100, the method 200, or any combination thereof.

In some embodiments, the AI software 120 and/or the AI-based hardware 122, the one or more data analysis algorithms and/or computer-generated sensory inputs associated with the AI software 120 and/or AI-based hardware 122, or any combination thereof may obtain one or more room dimensions and one or more room types of each room for the real estate property to be staged via the “restaged” application or website. The one or more room dimensions and/or the one or more room types of the real estate property to be staged may be obtainable from at least one document capturing software/hardware or data/information collected from one or more of the following measuring devices: at least one laser measuring device; at least one electronic tape measure device; at least one robotic measuring device; at least one electronic or digital room measure device; or any combination thereof. In an embodiment, the collected data/information regarding the room dimensions may include, for example, measurements of room details (i.e., doors, windows, doorways, etc.)

In at least one embodiment, the at least one document capturing software/hardware may capture one or more floor-plan images of the real estate property to be staged by the seller's agent. The seller's agent may display at least one floor-plan to a remote camera either incorporated into or in digital communication with either of the devices 102, 104. The AI software 120 and/or the AI-based hardware 122, and/or the one or more data analysis algorithms and/or computer-generated sensory inputs may detect and identify those images as at least one real estate floor-plan and then capture and convert the images or the real estate floor-plan to at least one of a user-friendly format, an AI-enabled format, or a combination thereof. The convert images or real estate floor-plan may be analyzed by the AI software 120 and/or the AI-based hardware 122, and/or the one or more data analysis algorithms and/or computer-generated sensory inputs. Alternatively, at least one measuring device may communicate the collected data/information to the system 100 and the AI software 120 and/or the AI-based hardware 122, and/or the one or more data analysis algorithms and/or computer-generated sensory inputs may analyze collected data/information received from the at least one measuring device. The rooms shown in the real estate floor plan or identified by the analysis of the collected data/information may each be labelled or assigned a room type via either of the devices 102, 104. The labelled or assigned room types for the rooms of the real estate property to be staged may be utilized by the AI software 120 and/or the AI-based hardware 122, and/or the one or more data analysis algorithms and/or computer-generated sensory inputs to select, determine, identify, and/or confirm the staging items and/or staging furniture to be added to the real estate property. As a result, the one or more digital photographs/images, the final VR/AR staged real estate listing, and/or the one or more virtual tours may be created, generated, or simulated by the AI software 120 and/or the AI-based hardware 122, and/or the one or more data analysis algorithms and/or computer-generated sensory inputs based on the analysis of the collected data/information, the labelled or assigned room types, or a combination thereof.

Examples in the present disclosure may also be directed to a non-transitory computer-readable medium storing computer-executable instructions and executable by one or more processors of the computer via which the computer-readable medium is accessed. A computer-readable media may be any available media that may be accessed by a computer. By way of example, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Note also that the software implemented aspects of the subject matter claimed below are usually encoded on some form of program storage medium or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A system for staging real estate properties, the system comprising:
at least one first digital device having a graphic user interface for receiving user input;
at least one computer server coupled to at least one database, wherein digital images of staging furniture are saved in the at least one database and accessible via the at least one computer server;
a digital communication network connected to the at least one first digital device and the at least one computer server such that the at least one first digital device digitally communicates with the at least one computer server via the digital communication network;
artificial intelligence software configured for selecting at least one digital image of at least one staging item from the digital images of the staging furniture based on the user input received from the at least one first digital device, wherein the at least one staging item comprises staging furniture for staging a room of a real estate listing; and
artificial intelligence hardware for executing the artificial intelligence software and in digital communication with the at least one first digital device and the at least one computer server,
wherein the selected at least one digital image of at least one staging item is displayable via the graphic user interface of the at least one first digital device.

2. The system of claim 1, wherein the user input comprises a geographical location of the real estate listing.

3. The system of claim 2, wherein the user input further comprises an acceptable geographical radius with respect to the geographical location of the real estate listing.

4. The system of claim 3, wherein the staging furniture is physically located within the acceptable geographical radius with respect to the geographical location of the real estate listing.

5. The system of claim 1, wherein the user input is a room type corresponding to the room of the real estate listing and/or dimensions of the room of the real estate listing.

6. The system of claim 1, further comprising:
at least one computer software application accessible via the at least one first digital device or the at least one computer server and configured to display or render the selected at least one digital image of at least one staging item.

7. The system of claim 1, wherein the artificial intelligence software comprises one or more data analysis algorithms and/or the artificial intelligence hardware comprises one or more computer-generated sensory inputs.

8. The system of claim 1, wherein the artificial intelligence hardware comprises at least one artificial intelligence accelerator selected from the group consisting of at least one graphics processing unit, at least one integrated graphics processor, at least one field programmable gate array, at least one application specific integrated circuit, or a combination thereof.

9. The system of claim 1, further comprising:
a virtual reality or augmented reality staged real estate listing accessible via the at least one first digital device or the at least one computer server and comprising the room of the real estate listing staged with the selected at least one digital image of at least one staging item.

10. A method for stagging rooms of real estate properties, the method comprising:
analyzing information associated with a plurality of staging furniture based on user input received from a first digital device, wherein information of the plurality of staging furniture is accessible from a database in digitally communication with the first digital device and comprises a geographical location of each furniture item of the plurality of staging furniture, the user input comprises a geographical location of a real estate listing to be staged and an acceptable geographical radius around the geographical location of the real estate listing;
selecting at least one furniture item from the plurality of staging furniture based on the analyzed information when the geographical location of the at least one furniture item is located within the acceptable geographical radius around the geographical location of the real estate listing; and
displaying the selected at least one furniture item via a computer software application that is accessible and displayable via the first digital device or at least one second digital device.

11. The method of claim 10, further comprising:
obtaining the selected at least one furniture item for staging at least one room of the real estate listing.

12. The method of claim 10, further comprising:
staging at least one room of the real estate listing with the selected at least one furniture item.

13. The method of claim 10, further comprising:
creating a staged room of the real estate listing by incorporating the selected at least one furniture item into the staged room of the real estate listing.

14. The method of claim 10, further comprising:
executing or performing one or more data analysis algorithms associated with artificial intelligence software when analyzing the information associated with the plurality of staging furniture based on the user input received from the first digital device.

15. The method of claim 14, wherein the one or more data analysis algorithms are executed or performed by artificial intelligence hardware.

16. The method of claim 15, wherein the artificial intelligence hardware comprises at least one artificial intelligence accelerator selected from the group consisting of at least one graphics processing unit, at least one integrated graphics processor, at least one field programmable gate array, at least one application specific integrated circuit, or a combination thereof.

17. A method for stagging rooms of real estate properties, the method comprising:
digitally communicating user input from a first digital device to a computer server via a first digital communication network, wherein the computer server is coupled to a database comprising digital images indicative of staging furniture;
executing artificial intelligence software to analyze information associated with the staging furniture based on the user input;
determining at least one furniture item from the staging furniture for virtually staging a room of a virtual real estate listing based on the analyzed information and the user input, wherein the user input comprises a room type indicative of the room of the virtual real estate listing;
incorporating, via the artificial intelligence software, at least one digital image of the determined at least one furniture item into the virtually staged room of the virtual real estate listing; and
rendering at least one digital image of the virtually staged room.

18. The method of claim 17, wherein artificial intelligence hardware executes the artificial intelligence software and comprises at least one artificial intelligence accelerator selected from the group consisting of at least one graphics processing unit, at least one integrated graphics processor, at least one field programmable gate array, at least one application specific integrated circuit, or a combination thereof.

19. The method of claim 17, further comprising:
generating a virtual tour of the virtual real estate listing comprising the at least one digital image of the virtually staged room.

20. The method of claim 17, wherein the at least one digital image of the virtually staged room is a virtual or augmented reality of the virtual real estate listing and comprises the at least one digital image of the determined at least one furniture item.
